(19) United States
(12) Patent Application Publication
(10) Pub. No.: US 2026/0289196 A1
(43) Pub. Date: Sep. 24, 2026

(54) SYSTEM

(71) Applicant: SoftBank Group Corp., Tokyo (JP)

(72) Inventor: Kazuo KAWATA, Tokyo (JP)

(73) Assignee: SoftBank Group Corp., Tokyo (JP)

(21) Appl. No.: 19/562,885

(22) Filed: Mar. 11, 2026

(30) Foreign Application Priority Data
Mar. 19, 2025 (JP) 2025-044970

(51) Int. Cl. G06F 40/58; G06F 40/10; G06F 40/279

(52) U.S. Cl. CPC G06F 40/58; G06F 40/10; G06F 40/279

(57) ABSTRACT

A system includes a processor that is configured to: analyze digital data and generate a prompt sentence for instructing a generative AI model to perform summarization, input the prompt sentence into the generative AI model to cause the generative AI model to generate summary information based on the digital data, and transmit the generated summary information to a user terminal via a network.

### CROSS-REFERENCE TO RELATED APPLICATION

This application is based on and claims priority under 35 USC 119 from Japanese Patent Application No. 2025-044970 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for generating summaries of digital data, such as official announcements and lectures, require a human operator to manually analyze the original content and to manually configure summarization conditions or prompts for a generative AI model. As a result, the summarization process is time-consuming, labor-intensive, and difficult to scale when the amount of digital data increases. In particular, when the digital data is long in duration, the processing time for generating a summary becomes excessively long, and timely dissemination of summarized information to user terminals through a network is not ensured. Furthermore, because prompts for instructing the generative AI model are often created in an ad hoc manner, the quality and consistency of the generated summary information can be unstable, especially when different operators or different types of content are involved. Therefore, there is a need for a system capable of automatically analyzing digital data, automatically generating appropriate prompt sentences for instructing a generative AI model, efficiently generating summary information even for long-duration digital data, and rapidly transmitting the generated summary information to user terminals via a network in a consistent and scalable manner.

### SUMMARY

In order to solve the above-described problems, the present invention provides a system comprising a processor, wherein the processor is configured to analyze digital data and generate a prompt sentence for instructing a generative AI model to perform summarization, input the prompt sentence into the generative AI model to cause the generative AI model to generate summary information based on the digital data, and transmit the generated summary information to a user terminal via a network. In one aspect, the processor is configured to receive official announcement digital data or lecture digital data as input data in order to analyze the digital data, and to generate the prompt sentence for instructing the generative AI model to perform summarization of the official announcement digital data or the lecture digital data, thereby enabling automatic generation of summary information suitable for official communications and presentations. In another aspect, the processor is configured to divide long-duration digital data into a plurality of pieces of divided data, to generate, for each piece of the divided data, a respective prompt sentence for instructing the generative AI model to perform summarization, and to perform summarization of the long-duration digital data in a shortened processing time by executing parallel processing of summarization based on the respective prompt sentences, thereby improving processing efficiency and enabling rapid provision of summary information to user terminals.

The term “system” refers to an arrangement of one or more hardware devices and software components that cooperate to perform the processing defined in the claims, including at least a processor and, optionally, memory, storage, and communication interfaces.

The term “processor” refers to a hardware processing unit, such as a central processing unit (CPU), a graphics processing unit (GPU), a digital signal processor (DSP), or any combination thereof, that executes instructions to perform analysis of digital data, generation of prompt sentences, interaction with a generative AI model, and transmission of summary information.

The term “digital data” refers to data represented in electronic form, including, but not limited to, audio files, video files, text files, image files, or structured data, which can be analyzed by the processor in order to generate summary information.

The term “prompt sentence” refers to a text string or set of text instructions generated by the processor, which is provided as an input to the generative AI model to cause the generative AI model to perform summarization of the digital data.

The term “generative AI model” refers to a machine learning model, such as a deep learning model or a large language model, that is capable of generating text or other content based on an input prompt sentence, and that produces summary information corresponding to the digital data.

The term “summary information” refers to information generated by the generative AI model that concisely represents the content of the digital data, including, for example, key points, main topics, or condensed descriptions derived from the original data.

The term “user terminal” refers to an electronic device operated by a user, such as a personal computer, a smartphone, a tablet, or a workstation, which is capable of receiving the summary information from the system via a network and presenting the summary information to the user.

The term “network” refers to any communication infrastructure that enables data transmission between the system and the user terminal, including, for example, the Internet, a local area network (LAN), a wide area network (WAN), or a wireless communication network.

The term “official announcement digital data” refers to digital data representing official communications of an organization, such as earnings announcements, press releases, or formal statements, which are intended to be disseminated to internal or external stakeholders.

The term “lecture digital data” refers to digital data representing spoken or presented content in a lecture, seminar, presentation, speech, or similar event, including both recorded audio or video and corresponding textual materials.

The term “long-duration digital data” refers to digital data having a length or size that requires an extended processing time for summarization when processed as a whole, such as a long video, a long audio recording, or a large text document.

The term “divided data” refers to portions of the long-duration digital data obtained by dividing the long-duration digital data into smaller segments or chunks, each of which can be processed individually by the generative AI model.

The term “parallel processing” refers to a processing method in which the processor, or a plurality of processors, performs summarization for a plurality of pieces of divided data concurrently or in an overlapping time manner, in order to reduce overall processing time.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

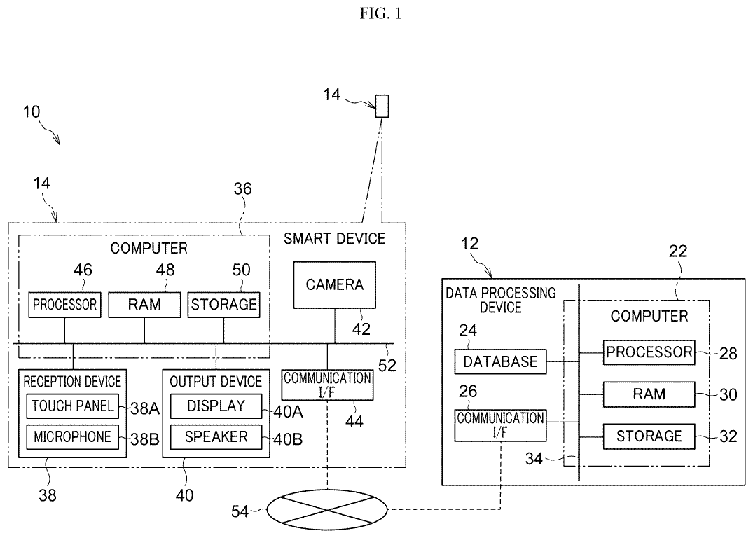

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

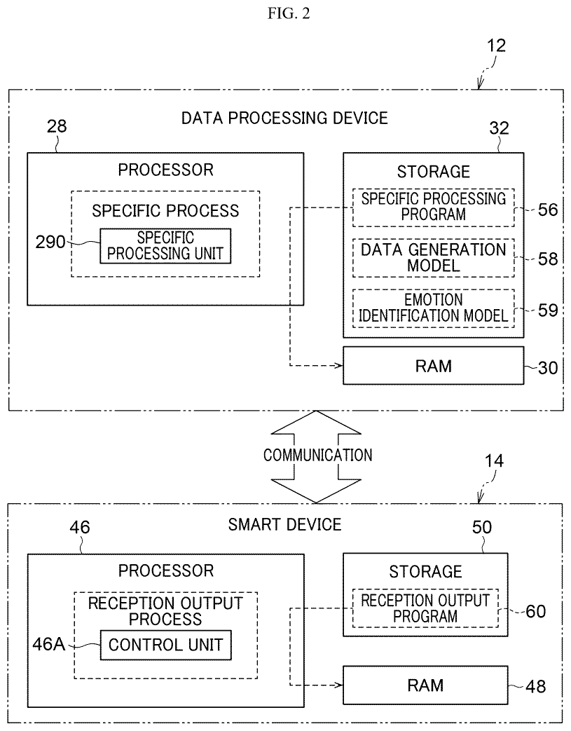

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional computer-implemented summarization systems, several technical problems arise in connection with the efficient utilization of computing resources, the robustness of processing heterogeneous digital content, and the generation of high-quality summaries suitable for downstream machine processing and human consumption.

First, many existing systems accept only a single type of input, such as plain text, and are not technically optimized to handle heterogeneous electronic information including video information, audio information, and document information in a unified pipeline. As a result, a server must rely on separate, loosely coupled tools for media extraction, speech recognition, and text normalization, which leads to inefficient data flow, redundant conversions, and increased processing latency on computer hardware.

Second, in many implementations, a generative AI model is directly invoked on a large amount of unstructured character information without any structured pre-extraction of important terms or topic information. This causes the model to consume significant computing resources on a processor and an accelerator, such as a graphics processing unit, to process irrelevant or low-value segments, which degrades throughput, increases memory consumption, and leads to unpredictable response times in a server environment. The absence of structured information also makes it difficult to generate consistent and controllable summaries, since the model receives only raw text and a simple instruction.

Third, typical systems do not systematically combine a user-specified prompt sentence with an internally generated prompt sentence that reflects the results of natural language processing. The lack of such a composite prompt structure prevents the server from effectively steering the generative AI model based on both user intent and machine-extracted key information, leading to unstable summary quality and requiring repeated user interaction. From a computer technology standpoint, this results in additional processing cycles, repeated model invocations, and inefficient utilization of network and processor resources.

Fourth, when processing long-duration video information or audio information, some systems attempt to summarize the entire content as a single unit. This often exceeds the input limitations of the generative AI model and causes memory pressure, model truncation, or failure during inference. Modern server hardware and model architectures are not fully leveraged, because input segmentation, parallel processing, and integration of partial results are not systematically implemented. Consequently, the server cannot exploit parallelism across multiple processor cores or multiple accelerators, and end-to-end latency becomes excessive.

Fifth, multilingual support is frequently implemented as an afterthought, with summary generation and translation handled by separate, uncoordinated modules. This disjointed design increases the number of data transfers between processes or services, introduces additional serialization and deserialization overhead, and complicates error handling on the server. Furthermore, summary information is often generated in a single language without explicit consideration of subsequent translation, resulting in sentences that are difficult to translate or that lead to inconsistent multilingual outputs.

Accordingly, there is a need for a technical solution that, within a server, (i) unifies the reception and preprocessing of heterogeneous electronic information, (ii) performs structured natural language processing to extract important terms and topic information, (iii) constructs a composite prompt sentence integrating user-specified summarization conditions and internally generated structured information, (iv) executes parallel summarization processing for divided segments of long-duration electronic information, and (v) generates multilingual summary information in a coordinated manner. Such a solution should improve the efficiency, scalability, and predictability of the summarization pipeline at the level of computer architecture and software components, thereby improving the functioning of the computer system itself rather than merely providing an abstract summarization scheme.

The specific processing by the specific processing unit 290 of the data processing device 12 in Example 1 is realized by the following means.

The present invention provides a server comprising a processor configured to receive and preprocess heterogeneous electronic information including video information, audio information, and document information via a communication network from a user terminal, to automatically extract an audio component from video information, to convert the audio component into a format suitable for speech recognition, to convert the audio component into character information by executing speech recognition processing, to extract character information from document information and normalize the character information, to execute natural language processing on the character information in order to extract important terms and topic information and to generate structured information including at least a portion of a character string to be summarized, to generate a prompt sentence by combining summarization conditions and a user-specified prompt sentence received from the user terminal with an internal prompt sentence including the structured information, to input the prompt sentence and the structured information into a generative AI model and generate summary information by executing inference processing based on deep learning, to when the electronic information includes long-duration video information or audio information, divide the electronic information into a plurality of partial segments, generate the prompt sentence for each partial segment, execute summarization processing by the generative AI model in parallel for the respective partial segments, and integrate partial summary information obtained from the respective partial segments to generate integrated summary information, to automatically translate the summary information or the integrated summary information into a plurality of languages to generate multilingual summary information, and to transmit the multilingual summary information to the user terminal via the communication network for display or storage. This enables the server to implement an integrated and resource-efficient summarization pipeline that improves computer performance by reducing redundant processing of unstructured data, exploiting parallelism in processor and accelerator resources, providing stable and controllable input to the generative AI model through composite prompt construction, and minimizing network and memory overhead associated with multilingual summary generation, thereby enhancing the overall functioning of the computer system.

The term “system” refers to a combination of hardware and software components that cooperate to perform reception, processing, generation, translation, and transmission of information as claimed.

The term “processor” refers to one or more hardware processing units, such as a central processing unit or an accelerator, configured to execute instructions that implement the claimed functions.

The term “electronic information” refers to machine-readable data including at least video information, audio information, and document information that are transmitted, stored, or processed in digital form.

The term “video information” refers to electronic information that includes a sequence of image frames, optionally accompanied by an audio component, encoded in a digital format.

The term “audio information” refers to electronic information that includes sound signals, such as speech or other acoustic data, encoded in a digital format.

The term “document information” refers to electronic information representing textual or mixed text-and-graphics content, including but not limited to digitally stored documents, files, or messages.

The term “user terminal” refers to an information processing device operated by a user, such as a client computer or a mobile device, that communicates with the server via a communication network.

The term “communication network” refers to a wired or wireless data communication infrastructure, such as a local area network, a wide area network, or a public network, through which electronic information is transmitted between the server and the user terminal.

The term “preprocess” refers to performing one or more operations on received electronic information to convert it into a format or structure suitable for subsequent processing, analysis, or inference.

The term “audio component” refers to the portion of video information that encodes sound signals associated with the sequence of image frames.

The term “format suitable for speech recognition processing” refers to a representation of audio information, such as a specified sampling rate, bit depth, and channel configuration, that meets predetermined conditions required by a speech recognition algorithm or system.

The term “speech recognition processing” refers to a process of converting audio information representing speech into corresponding character information using pattern recognition, statistical modeling, or machine learning techniques.

The term “character information” refers to a sequence of symbols representing text, including but not limited to letters, numerals, punctuation marks, and control characters, that can be processed by text-handling software.

The term “normalize” refers to applying operations to character information to unify its representation, such as standardizing character encodings, removing noise, correcting spacing, or performing consistent segmentation.

The term “natural language processing” refers to computational techniques that analyze or generate human language, including operations such as tokenization, part-of-speech tagging, semantic analysis, key term extraction, and topic identification.

The term “important terms” refers to words or phrases extracted from character information that are determined, by a predetermined algorithm or model, to be salient or relevant for describing the content.

The term “topic information” refers to data indicating one or more subjects or themes discussed in the character information, derived by a topic analysis or clustering method.

The term “structured information” refers to data organized into a defined format, such as lists, key-value pairs, or annotated segments, including at least important terms, topic information, and one or more character strings selected as candidates for summarization.

The term “character string to be summarized” refers to a portion of character information that is selected as an input or basis for generating summary information.

The term “summarization conditions” refers to parameters or constraints that specify how summary information should be generated, including at least length, focus, style, or target audience requirements.

The term “prompt sentence” refers to a text instruction or set of text instructions input to a generative AI model to guide the generation of output, including summary information.

The term “user-specified prompt sentence” refers to a prompt sentence directly provided or edited by a user via the user terminal to indicate desired summarization conditions or output characteristics.

The term “internal prompt sentence” refers to a prompt sentence automatically generated by the processor based on structured information and other system-derived context, without direct manual input of the user.

The term “generative AI model” refers to a trained machine learning model, such as a neural network, configured to generate text output in response to input text, including prompt sentences and contextual information.

The term “inference processing based on deep learning” refers to a computational procedure that applies a trained deep neural network to input data to produce output data, without updating model parameters during that procedure.

The term “summary information” refers to character information that concisely expresses essential content derived from electronic information, based on one or more summarization conditions.

The term “long-duration video information” refers to video information having a duration that exceeds a predetermined threshold such that direct processing as a single unit is impractical or inefficient for a generative AI model.

The term “long-duration audio information” refers to audio information having a duration that exceeds a predetermined threshold such that direct processing as a single unit is impractical or inefficient for a generative AI model.

The term “partial segments” refers to discrete portions obtained by dividing long-duration video information or long-duration audio information into smaller units according to time or data size.

The term “summarization processing by the generative AI model in parallel” refers to the execution of multiple instances of inference processing by one or more generative AI models concurrently for different partial segments, utilizing parallel execution capabilities of hardware or software.

The term “partial summary information” refers to summary information generated separately for each partial segment of long-duration video information or long-duration audio information.

The term “integrated summary information” refers to summary information produced by combining or consolidating multiple items of partial summary information into a unified summary.

The term “automatically translate” refers to converting character information from a source language to one or more target languages by using a machine translation process executed by software, without human intervention for each translation instance.

The term “multilingual summary information” refers to a set of summary information instances that express substantially the same summarized content in two or more different languages.

The term “display or storage” refers to making information available for viewing on an output device of the user terminal and/or recording information in a memory or storage medium of the user terminal.

In one embodiment, a server implements the claimed system as a network-accessible summarization platform. The server includes at least one processor, a main memory, a non-volatile storage device, and a network interface, and executes an operating system such as a general-purpose server operating system. The server further executes application software including a web application framework, a media processing component, a speech recognition component, a natural language processing component, a generative AI model execution component, and a machine translation component. The server cooperates with at least one terminal operated by a user via a communication network.

The terminal can be a client device such as a personal computer, a tablet, or a smartphone. The terminal executes a client application, such as a browser-based user interface or a native application, that enables the user to select electronic information, input a prompt sentence, and receive multilingual summary information. The user operates the terminal through standard input devices such as a touch panel, a keyboard, or a pointing device.

The server receives heterogeneous electronic information, such as video information, audio information, and document information, from the terminal via the communication network. In one implementation, the server uses a web application framework such as a generic HTTP server framework to accept upload requests sent using a secure transport protocol. The server stores the received files in a file system or in a distributed object storage system. By centralizing the reception and storage within a single server-side application, the system reduces redundant input/output operations and avoids the need for multiple separate ingestion services.

When the electronic information includes video information or audio information, the server uses a media processing component such as a multimedia processing library to extract an audio component from the video stream. The server configures the media processing component to convert the audio component into a unified format, for example, a single-channel waveform with a predetermined sampling rate and bit depth. This conversion reduces variability in audio formats and thereby simplifies subsequent speech recognition processing, improving recognition stability and reducing the number of format conversion failures.

The server performs speech recognition processing on the normalized audio component using a speech recognition engine. In one embodiment, the server executes a neural network-based speech recognition model that is implemented using a deep learning framework such as a general neural network library and runs on accelerator hardware such as a graphics processing unit. The speech recognition model may employ a sequence-to-sequence architecture with an encoder and a decoder, or a transformer-based acoustic model combined with a language model. The server configures the speech recognition model with parameters including a sampling rate, a feature extraction method (for example, mel-frequency cepstral coefficients or log-mel spectrograms), and decoding parameters (for example, beam width and language model weight). By fixing these parameters, the system achieves stable recognition latency and consistent accuracy across different input sources. The server converts the audio frames into feature vectors, feeds the feature vectors into the speech recognition network, and decodes output probability distributions into character information using an algorithm such as beam search. This structured speech recognition pipeline improves error resistance compared with manual transcription or ad hoc recognition calls.

When the electronic information includes document information, the server extracts character information from the document using a document parsing component. In one embodiment, the server uses a document parsing library capable of handling multiple document formats, such as portable document formats and plain text formats. The server reads the document file, extracts embedded text, and normalizes line breaks, encoding, and white space. The server converts the extracted content into a standardized internal character encoding to ensure that subsequent natural language processing operates on a uniform representation.

The server performs normalization operations on the character information, including tokenization, removal of non-textual tokens, and sentence segmentation. In one embodiment, the server uses a natural language processing library to detect sentence boundaries and to standardize punctuation. This normalization ensures that later models receive text segments of manageable length, which reduces memory usage and prevents model input truncation.

The server executes natural language processing on the normalized character information to extract important terms and topic information, and to generate structured information. In one example, the server computes term frequencies and inverse document frequencies over the character information and uses these values to identify noun phrases and key phrases that exhibit high salience scores. The server may further apply a topic modeling algorithm such as latent Dirichlet allocation or a clustering-based algorithm on sentence embeddings produced by a transformer-based encoder. Each sentence or paragraph can be transformed into a fixed-length numerical vector, and the server groups vectors into clusters that represent topics. The server stores, for each topic, representative key phrases and representative sentences.

The server organizes the results of this analysis into a structured information representation. In one embodiment, the structured information is implemented as a record containing fields such as a list of important terms, a list of topics, and a list of excerpted character strings selected as candidates for summarization. Each excerpted character string may be associated with metadata, such as a timestamp for video or audio content, a source section identifier, and a salience score. This structured information is generated by machine-specific algorithms that are optimized to select segments that are likely to represent high-value content for summarization. The machine uses numerical thresholds and ranking procedures that are not typically applied by human summarizers, thus enabling consistent and repeatable selection of content.

The user uses the terminal to input summarization conditions and a user-specified prompt sentence that indicate the desired characteristics of the summary. For example, the user may input the following prompt sentence via an input field presented on the terminal:
“Please summarize the main decisions and action items of this meeting in about 200 words.”

In another example, the user may input:
“Create a short, easy-to-understand summary of this podcast for a non-expert audience, and list three key takeaways.”

The terminal transmits the user-specified prompt sentence and the summarization conditions to the server, together with an identifier that links to the previously uploaded electronic information. The server stores the prompt sentence and conditions in association with the structured information. The server generates an internal prompt sentence that reflects the structured information derived from the character information. For example, the server may construct an internal prompt format that includes the list of important terms, topic information, and example sentences flagged as highly salient. An internal prompt template may have a structure such as:
“Context: key phrases=[list]; topics=[list]; representative sentences=[list].”

The server combines the user-specified prompt sentence and the internal prompt sentence into a single composite prompt sentence. In one embodiment, the server concatenates the user-specified instruction at the beginning, followed by the structured context paragraphs. For example, the server may construct a composite prompt sentence such as:
“User instruction: Please summarize the main decisions and action items of this meeting in about 200 words.

Context: Here are important terms and topics extracted from the transcript: [list of terms and topics].

Representative excerpts: [list of salient sentences].

Generate a coherent summary that follows the user instruction and focuses on the decisions and action items.”

By assembling the composite prompt sentence in this manner, the server shapes the input to the generative AI model using machine-derived structure that is not limited to simple user instructions. This reduces the amount of irrelevant content that the generative AI model must process and lowers the number of tokens or internal states that the model must handle during inference, thereby reducing memory consumption and inference time.

The server uses a generative AI model to produce summary information based on the composite prompt sentence and the structured information. In one embodiment, the generative AI model is implemented as a transformer-based neural network with multiple self-attention layers, residual connections, and feed-forward sublayers. The model may be trained in advance on large corpora using an auto-regressive or sequence-to-sequence objective, such as predicting the next token or generating a target sequence from a source sequence. The server deploys the trained model using a deep learning framework, and loads the model parameters into accelerator memory.

The server encodes the composite prompt sentence and any additional structured tokens into numerical token identifiers using a tokenizer associated with the chosen model architecture. The server then feeds the token sequence into the generative AI model, which computes attention weights and hidden states layer by layer. In this process, the model internally multiplies the token embeddings by weight matrices, applies non-linear activation functions, and aggregates contextual information. The server configures decoding parameters such as maximum output length, temperature, and beam width so as to control the trade-off between diversity and determinism. Because the composite prompt sentence already isolates relevant content and user intent, the model can converge on a high-quality summary with fewer decoding steps and fewer corrective iterations, thus improving computational efficiency.

In one embodiment, when the electronic information includes long-duration video information or long-duration audio information, the server divides the original content into multiple partial segments according to temporal boundaries or data size constraints. For instance, the server can split an hour-long recording into segments of several minutes each. The server then applies speech recognition, normalization, and natural language processing to each segment independently, producing structured information for each partial segment. The server constructs a composite prompt sentence for each segment and invokes multiple parallel inference processes or threads to perform summarization processing by the generative AI model concurrently. This parallelization exploits the multi-core nature of the processor and the capability of multiple accelerators, reducing total processing time and avoiding the need to load extremely long sequences into a single model run. After generating partial summary information for each segment, the server executes an integration procedure that aggregates the partial summaries, optionally re-running a lighter-weight generative model or rule-based merging algorithm to create integrated summary information for the entire content.

The server provides multilingual support by automatically translating summary information or integrated summary information into a plurality of languages. In one embodiment, the server uses neural machine translation models running on the same hardware platform, or calls external translation services as needed. The server structures the translation process to minimize redundant conversions, for example by translating from a base language representation once into multiple target languages rather than re-translating from different intermediate versions. The server also tailors sentence segmentation before translation so that the translation models receive well-formed units, which improves translation quality and reduces the number of correction cycles. The resulting multilingual summary information is then transmitted from the server to the terminal via the communication network. The terminal displays the summaries in different languages and allows the user to store or share the summary information.

The system improves computer technology in several ways. By performing early-stage extraction of important terms and topic information, the server significantly reduces the volume of data that must be processed by the generative AI model. This leads to reduced memory footprint during inference, lower computation time per request, and higher throughput on shared hardware. By dividing long-duration content into partial segments and running model inference in parallel, the server achieves better utilization of multi-core and multi-accelerator resources, reducing latency for long documents that would otherwise exceed model input limits or cause timeouts. The composite prompt sentence, which combines user-specified instructions and internal machine-derived structure, provides the generative AI model with a constrained and context-rich input that enables more deterministic behavior and improves summary consistency. Because the server applies non-human, machine-optimized policies for selecting and structuring context, the system is not merely automating human summarization practices but is introducing novel computational strategies that leverage data structures and algorithms designed for efficient model guidance.

The neural models used for speech recognition, natural language processing, summarization, and translation are trained using supervised or self-supervised learning procedures on pre-existing datasets. During training, the models use error functions such as cross-entropy loss or sequence-level loss, and apply gradient-based optimization methods such as stochastic gradient descent or variants thereof to update their weight parameters. The server may employ regularization techniques, data augmentation strategies, or curriculum learning schedules to improve generalization and robustness. These training details directly influence the runtime behavior of the models on the server, such as the degree of tolerance to noise in audio signals, the ability to identify domain-specific terms, and the accuracy of summary generation. Thus, the disclosed system is grounded in specific machine learning architectures and training methodologies rather than abstract and unspecified “AI processing.”

Alternative embodiments are also possible within the scope of the claims. For example, the server may use different architectures for the generative AI model, such as encoder-decoder transformers, decoder-only transformers, or hybrid models that combine recurrent layers and attention mechanisms. The natural language processing component may utilize different algorithms for key term extraction, including graph-based ranking methods or supervised classifiers. The segmentation of long-duration content may be adaptive, based on detected topic shifts or silence intervals in audio, rather than fixed time windows. The translation component may be integrated as a multi-task extension of the summarization model, allowing a single neural network to perform both summarization and translation, thereby decreasing total parameter count and reducing inter-process communication. These variations still maintain the fundamental structure of the system, in which the server integrates heterogeneous data preprocessing, structured natural language analysis, composite prompt construction, generative summarization, parallel segment processing, and multilingual output generation.

Through these configurations, the server, the terminal, and the user cooperate to realize a concrete technical system that improves the efficiency, scalability, and reliability of computer-based summarization and multilingual delivery of content. The system's design, including specific data structures, neural architectures, and algorithmic flows, provides technical effects such as processing speed improvement, resource usage optimization, and accuracy enhancement that go beyond a mere automation of human mental processes.

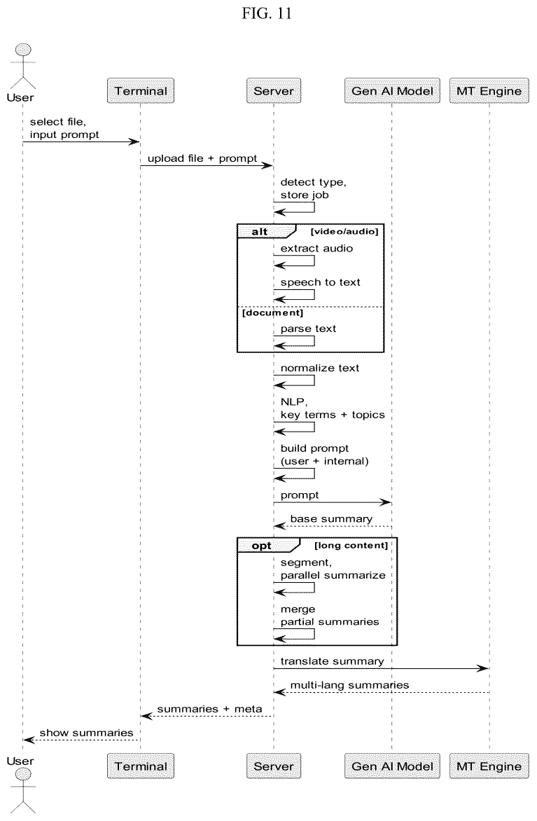

The following describes the processing flow using FIG. 11.

### Step 1:

The user operates the terminal to select electronic information and input summarization conditions. The terminal displays a file selection interface and a text input field. The user chooses a file such as a video file, an audio file, or a document file, and types a prompt sentence, for example: “Please summarize the main decisions and action items of this meeting in about 200 words.” The input of this step is user interaction events (file selection and text entry) on the terminal. The output of this step is a request object on the terminal that includes a reference to the selected file, the user-specified prompt sentence, and meta-information such as desired output languages.

### Step 2:

The terminal transmits the request object and the selected file to the server via a communication network. The terminal opens a secure connection and sends the file data together with the prompt sentence and metadata in a structured request. The input of this step is the local request object and the file bytes stored on the terminal. The output of this step is a network message delivered to the server that contains the electronic information, the prompt sentence, and associated parameters.

### Step 3:

The server receives the network message and registers a processing job. The server validates file type and size, checks that a prompt sentence is present, and stores the raw file in a storage system. The server writes a job record into an internal data store, associating the stored file path with the prompt sentence and requested target languages. The input of this step is the received network message. The output of this step is a persistent job entry containing identifiers, file location, and user-defined summarization conditions.

### Step 4:

The server analyzes the job record and determines the type of electronic information. If the file is video information, the server classifies it as containing both visual and audio content; if the file is audio information, the server marks it as audio-only; if the file is document information, the server marks it as text-based. The server inspects file headers and extensions to derive this classification. The input of this step is the stored file and metadata. The output of this step is a content-type label attached to the job record indicating video, audio, or document.

### Step 5:

The server, when the content type is video or audio, performs media preprocessing and audio normalization. The server calls a media processing component to extract an audio component from video information and to resample the audio to a predetermined sampling rate and channel format. The server converts compressed audio formats into a raw waveform suitable for speech recognition. The input of this step is the stored video or audio file. The output of this step is a normalized audio file or buffer that conforms to the required format for further processing.

### Step 6:

The server, when the content type is document information, executes document parsing and text extraction. The server loads the document file with a document parsing component and extracts embedded text streams. The server resolves encoding issues, removes binary elements, and merges fragmented text segments. The input of this step is the stored document file. The output of this step is raw character information representing the document content in a unified internal encoding.

### Step 7:

The server, for normalized audio, performs speech recognition processing to convert audio signals into character information. The server computes acoustic features such as spectrograms from the waveform, feeds these features into a trained neural speech recognition model, and decodes the model's output probabilities into text sequences. The model may use beam search to select the most likely sequence. The input of this step is the normalized audio file or buffer. The output of this step is transcribed character information with optional timing information for each segment.

### Step 8:

The server normalizes the character information regardless of whether it originated from speech recognition or document parsing. The server segments the text into sentences, standardizes punctuation, removes obvious noise markers, and corrects spacing inconsistencies. The server may also transform all text into a standard case or script, depending on language. The input of this step is raw character information. The output of this step is normalized character information organized into clean, sentence-level units.

### Step 9:

The server executes natural language processing on the normalized character information to extract important terms and topic information. The server applies tokenization, part-of-speech tagging, and key phrase extraction algorithms, then computes salience scores such as TF-IDF values. The server additionally generates sentence embeddings and performs clustering or topic modeling to identify thematic groups. The input of this step is normalized character information. The output of this step is structured information including lists of important terms, topic labels, and selected representative sentences with associated scores.

### Step 10:

The server constructs an internal prompt sentence based on the structured information. The server formats important terms as a list, describes detected topics, and concatenates representative sentences into a context section. The server creates a text block such as: “Context: key phrases=[. . . ]; topics=[. . . ]; representative excerpts=[. . . ].” The input of this step is the structured information produced by natural language processing. The output of this step is an internal prompt sentence that encodes the extracted structure in natural language form.

### Step 11:

The server combines the user-specified prompt sentence with the internal prompt sentence to create a composite prompt sentence for a generative AI model. The server places the user's instruction at the beginning, attaches the internal context block, and may add explicit guidance on style or output length based on the summarization conditions. The server thus produces a unified text that instructs the model both with user intent and machine-derived context. The input of this step is the user-specified prompt sentence and the internal prompt sentence. The output of this step is the composite prompt sentence that will be provided to the generative AI model.

### Step 12:

The server prepares model inputs for the generative AI model by converting the composite prompt sentence and, when needed, additional structured tokens into numerical token identifiers. The server calls a tokenizer associated with the model architecture, maps each character sequence into token IDs, and constructs an input tensor within a maximum sequence length. The input of this step is the composite prompt sentence and optional structured information. The output of this step is a tokenized representation ready for inference by the generative AI model.

### Step 13:

The server uses the generative AI model to generate summary information from the tokenized input. The server loads the model parameters into memory, feeds the input tensor to the model, and runs forward propagation through multiple neural network layers. The server iteratively decodes output tokens using a configured decoding strategy until a termination condition is met. The server then converts the output token IDs back to a text sequence that forms the base summary. The input of this step is the tokenized input tensor. The output of this step is base summary information expressed as character information in a primary language.

### Step 14:

The server, when the electronic information is long-duration video or audio, divides the content into partial segments and repeats Steps 5 through 13 for each segment in parallel. The server creates time-based segments, launches independent processing threads or tasks for each segment, and aggregates the partial summary information after all parallel tasks complete. The server then optionally passes the concatenated partial summaries through a lighter summarization routine to generate integrated summary information. The input of this step is the original long-duration electronic information. The output of this step is integrated summary information representing the entire content.

### Step 15:

The server performs multilingual translation of the base summary information or the integrated summary information into multiple languages. The server sends the summary text to one or more translation components, receives translated text in target languages, and associates each translated version with a language identifier. The input of this step is summary information in the base language. The output of this step is multilingual summary information containing corresponding summaries in several languages.

### Step 16:

The server assembles a response payload that includes the summary information and multilingual variants, together with optional metadata such as detected topics and processing time. The server formats this payload into a structured response suitable for transmission and updates the job record status to complete. The input of this step is multilingual summary information and related metadata. The output of this step is a response object ready to be sent to the terminal.

### Step 17:

The terminal receives the response object from the server via the communication network. The terminal parses the received data, extracts the multilingual summaries, and updates its user interface. The input of this step is the response object delivered by the server. The output of this step is an internal display model on the terminal that holds the summaries and allows user interaction.

### Step 18:

The user interacts with the terminal to view, store, or further refine the summaries. The user selects a desired language tab, reads the displayed summary, and may choose to save the summary locally or share it through communication applications. If the user is not satisfied, the user may input an additional prompt sentence such as: “Rewrite the summary focusing only on action items and deadlines, and limit it to 150 words.” The input of this step is the displayed summary information on the terminal and user control actions. The output of this step is either final user consumption of the summary or a new request including a refinement prompt sentence, which returns the flow to earlier steps on the server.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In modern computing environments, large volumes of multimedia content such as video streams, audio streams, and other viewing media are generated and consumed over communication networks. Conventional systems typically require a human user to manually watch or listen to most or all of the viewing medium in order to understand its essential content. Even when automatic transcription or simple keyword extraction is available, such systems generally present unstructured text or static summaries that are not tightly integrated with the underlying media timeline and are not optimized for real-time interaction or for operation across multiple languages. From a computer-technology perspective, these conventional approaches suffer from several technical shortcomings. First, processing pipelines for media analysis, speech recognition, natural language processing, and generative summarization are often implemented as loosely coupled components, which leads to redundant data transfer, inefficient use of computational resources, and increased latency in providing useful information to the user. Second, many existing systems treat generative AI models as standalone black boxes, without programmatically constructing prompt sentences in a way that exploits contextual information such as segmented transcripts or temporal structure of the media; as a result, the quality, determinism, and efficiency of the generated summaries are limited. Third, conventional systems generally lack mechanisms to generate and maintain association information that directly links summary segments to corresponding playback sections of the viewing medium data, which prevents the computing system from providing interactive navigation between abstracted information and the underlying media content. Fourth, existing systems do not fully support streaming scenarios in which sequential data is processed incrementally to provide real-time, updated summaries while the media is still being received and rendered, leading to degraded usability and increased processing delay. Fifth, storage and reuse of transcripts, prompt sentences, and generated summaries are typically ad hoc, making it difficult to systematically re-execute re-summarization or analysis with different prompt sentences or model configurations without reconstructing the entire processing pipeline.

Accordingly, there is a need for an improved computer-implemented system that integrates media separation, speech recognition, natural language processing, dynamic prompt construction, generative AI-based summarization, multilingual conversion, and summary-to-media association management in a coordinated processing architecture. Such a system should reduce latency, improve the efficiency and scalability of processing large or streaming viewing medium data, provide structured summary information that is programmatically linked to media playback positions, and enable real-time and multilingual access to summarized content. There is also a need for a system that records intermediate and final results together with identification information so that re-summarization and further analysis using different prompt sentences can be executed without re-processing raw media, thereby improving the overall performance and flexibility of the computing environment.

The specific processing by the specific processing unit 290 of the data processing device 12 in Application Example 1 is realized by the following means.

The present invention provides a server comprising a processor configured to receive viewing medium data as input data and separate the viewing medium data into an audio component and a video component in an information processing environment, to execute speech recognition processing on the audio component to generate character information, to execute natural language processing on the character information to structure the character information on a sentence basis and format the structured character information as summarization target information, to construct a prompt sentence that instructs generation of summary information based on the summarization target information and to input input data including the prompt sentence and the summarization target information into a generative artificial intelligence model so as to generate the summary information by using the generative artificial intelligence model, to execute conversion processing on the summary information into different languages in response to a user request so as to generate multilingual summary information, to transmit the summary information and the multilingual summary information in a machine-readable format to a user information processing terminal via a communication network, to generate association information indicating a correspondence between the summary information and the viewing medium data and to transmit the association information to the user information processing terminal so that, in accordance with a user operation, a playback section of the viewing medium data corresponding to the summary information is selectable from the summary information, and to store the viewing medium data, the character information, the prompt sentence, and the summary information in association with identification information and to re-execute re-summarization processing or analysis processing by using a different prompt sentence based on stored contents. This enables a coordinated, computer-implemented processing pipeline that efficiently transforms raw viewing medium data into structured, multilingual summary information that is interactively linked to media playback positions, reduces processing latency for both batch and streaming media, improves utilization of computational resources for generative AI-based summarization, and allows flexible re-summarization and analysis without re-processing the original media, thereby improving the functioning of the underlying computer system in handling large-scale multimedia content.

The term “viewing medium data” refers to digital data representing content intended to be viewed or listened to by a user, including at least one of video streams, audio streams, and multimedia files that contain time-based media information.

The term “audio component” refers to a portion of viewing medium data that encodes audible information, such as speech or environmental sounds, and that is separable from a corresponding visual portion by signal processing or decoding.

The term “video component” refers to a portion of viewing medium data that encodes visual information, such as image frames or motion pictures, and that is separable from a corresponding audio portion by signal processing or decoding.

The term “speech recognition processing” refers to a computational procedure that receives audio data as input and outputs character information representing a textual transcription of spoken content contained in the audio data.

The term “character information” refers to digital text data representing linguistic content, including sequences of characters, symbols, or tokens obtained by transcribing or otherwise converting audio or other media into textual form.

The term “natural language processing” refers to a set of computational techniques that analyze and transform character information expressed in a human language, including at least one of tokenization, sentence segmentation, syntactic analysis, semantic analysis, and text normalization.

The term “summarization target information” refers to structured character information that has been processed by natural language processing and formatted to serve as input content for generating a summary.

The term “prompt sentence” refers to text data that includes an instruction or request specifying how a generative AI model is to process given input content, including at least one of a desired task, output format, level of detail, or language.

The term “generative artificial intelligence model” refers to an information processing model that receives input data including a prompt sentence and content to be processed, and generates new text or other data by applying machine learning, such as neural network-based language modeling.

The term “summary information” refers to character information generated by a generative artificial intelligence model that expresses, in a condensed form, essential points or main ideas of the summarization target information or the viewing medium data.

The term “conversion processing” refers to computational processing that transforms summary information from a first language into one or more second languages while preserving semantic content to generate translated text.

The term “multilingual summary information” refers to summary information that is available in two or more languages as a result of conversion processing applied to an original summary.

The term “user information processing terminal” refers to any computing device operated by or accessible to a user, including but not limited to a smartphone, tablet, personal computer, or head-mounted display, that can communicate with a server over a communication network.

The term “communication network” refers to any wired or wireless infrastructure that enables data transmission between a server and a user information processing terminal, including at least one of a local area network, a wide area network, and a public communication network.

The term “machine-readable format” refers to a representation of data structured for automatic processing by a computing device, including at least one of structured text, markup language, or serialized data formats.

The term “association information” refers to data indicating a correspondence between elements of summary information and respective sections or time positions within viewing medium data, enabling navigation from summaries to media playback locations.

The term “playback section” refers to a temporal segment or interval within viewing medium data that can be selectively reproduced by a media playback function in response to control information.

The term “identification information” refers to data that uniquely or distinctively identifies at least one of viewing medium data, character information, prompt sentences, summary information, users, or sessions, and that can be used to associate related records in storage.

The term “re-summarization processing” refers to a procedure in which stored character information or previously summarized content is processed again, using a different prompt sentence or model configuration, to generate new summary information.

The term “analysis processing” refers to a computational operation applied to stored viewing medium data, character information, prompt sentences, or summary information, including at least one of classification, clustering, keyword extraction, or statistical evaluation.

The term “sequential data” refers to viewing medium data that is received or processed in a time-ordered manner, such as a continuous stream of audio or video segments, rather than as a single complete file.

The term “temporal division” refers to a subdivision of sequential data into time-based units or segments, each corresponding to a portion of the overall duration of the viewing medium data.

The term “update information” refers to summary information or related data that is generated and transmitted incrementally over time, reflecting newly processed portions of sequential data during ongoing reception or playback.

In one embodiment, a server cooperates with one or more terminals operated by a user to implement the claimed system. The server includes at least one hardware processor, a main memory, a non-volatile storage device, and a network interface, for example in the form of a general-purpose computer or a rack-mounted server with a multi-core central processing unit and optionally one or more graphics processing units. The terminal includes an imaging device, an audio input device, a display device, a local processor, a local memory, and a communication interface, for example in the form of a smartphone, a tablet, a personal computer, or a head-mounted display.

The server executes an operating system and application software that implement media separation, speech recognition, natural language processing, dynamic prompt sentence construction, execution of a generative AI model, multilingual conversion, association information generation, and storage and retrieval of intermediate and final results. The server, in one example, executes software implemented in a high-level programming language and uses standard libraries for media processing, speech recognition, and natural language processing.

The server receives viewing medium data from the terminal via a communication network. The terminal captures or selects viewing medium data using its camera and microphone subsystems and encodes the captured content into a compressed multimedia format managed by a media framework of an operating system. The terminal transmits the encoded viewing medium data to the server via a secure communication protocol. By offloading the heavy media analysis and generative summarization processing to the server, the system enables terminals with limited resources to provide advanced summary functions without executing computationally intensive models locally.

The server separates the received viewing medium data into an audio component and a video component. The server uses a media processing module that decodes a container format and extracts separate streams. The media processing module operates on a time-indexed data structure representing frames and samples of the viewing medium data. The server maintains an index mapping between frame timestamps and sample timestamps so that later association information between summary segments and playback sections can be computed efficiently. This separation and indexing improve the computational efficiency of subsequent processing because audio-only data is used for speech recognition and long video frames are not redundantly processed.

The server performs speech recognition processing on the audio component. The server, for example, uses a speech recognition engine that converts audio samples into a sequence of phonetic or subword units and then decodes these into character information. The speech recognition engine internally uses a neural network model, such as a convolutional and recurrent or transformer-based acoustic model, trained on large amounts of speech data. The server passes the audio component as an array of discrete time-domain samples or as a time-frequency representation (for example, mel-frequency spectrograms) to the speech recognition engine. The engine applies a series of linear and non-linear transformations, such as convolution, self-attention, and normalization, to produce probability distributions over linguistic units, and then decodes the most probable sequence using a beam search algorithm or similar decoding method. The server outputs character information as a text string annotated with timing metadata. By using a trained neural architecture with optimized decoding, the server improves transcription accuracy and robustness versus simple keyword spotting or manual transcription, thereby reducing transcription errors propagated to later summarization steps.

The server executes natural language processing on the character information to obtain summarization target information. The server uses a language processing library to perform tokenization, sentence segmentation, part-of-speech tagging, and optional syntactic or semantic annotation. The server, for example, applies sentence boundary detection to split the character information into discrete sentence units, and then converts the text into a structured representation, such as a list of sentences with associated token sequences and linguistic tags. The server may remove disfluencies, repeated fillers, or non-lexical symbols that often appear in spontaneous speech. The server may also perform language detection and, when necessary, normalize punctuation and casing. As a result, the summarization target information is stored as a structured data object that can be processed segment by segment, improving the determinism and efficiency of the subsequent summarization process.

The server constructs a prompt sentence based on the summarization target information. The server does not simply pass the raw text to a generative AI model; instead, the server programmatically composes a prompt sentence that encodes explicit instructions for the task, output format, length, and language. For example, the server may construct the following prompt sentence when the viewing medium data corresponds to a news report:
“Summarize the key points of the following news report in English. Focus on what happened, who was involved, when and where it occurred, and what impact it has on society. Provide the answer in 5 short bullet points. Transcript: [transcribed text].”

When the viewing medium data corresponds to a business meeting, the server may construct a different prompt sentence:
“Summarize the following meeting transcript in English. Extract only action items and decisions, and present them as numbered bullet points suitable for an internal email. Transcript: [transcribed text].”

When the viewing medium data is a live speech in a different language, the server may construct a further prompt sentence:
“The following is a transcript of a Japanese conference talk. Summarize the main thesis, methods, and conclusions in Japanese in about 200 words, suitable for expert readers. Transcript: [transcribed text].”

The server stores and manages these prompt sentences as separate entities associated with particular processing sessions. The server may select a prompt template based on metadata about the viewing medium data, such as its category (news, lecture, meeting), duration, or language, and may dynamically adjust instructions based on the length of the summarization target information. This explicit prompt management allows the server to control the behavior of the generative AI model in a systematic, reproducible manner and not merely rely on ad hoc human-written instructions.

The server inputs the constructed prompt sentence together with the summarization target information into a generative AI model. In one embodiment, the generative AI model is implemented as an encoder-decoder transformer network trained as a sequence-to-sequence model. The encoder maps the tokenized summarization target information and prompt tokens into contextual embeddings using multiple layers of self-attention and feedforward sub-layers. The decoder receives the encoded context and generates output tokens autoregressively, with cross-attention to the encoder outputs. The model parameters, including weights and biases of attention heads and feedforward layers, are optimized during prior training using large-scale text corpora and supervised summarization datasets. During inference for this system, the server applies a constrained decoding strategy, such as beam search with a restricted beam width and length penalties, to limit computation and enforce the requested output length and format.

The server converts the prompt sentence and the summarization target information into token sequences using a tokenizer associated with the generative AI model. The server then performs batch processing or streaming processing depending on the size of the input. For long viewing medium data, the server divides the summarization target information into multiple segments and constructs a separate prompt sentence for each segment. The server submits these prompt-segment combinations to the generative AI model in parallel, for example by scheduling them across multiple processing threads or across multiple accelerator devices. The server then concatenates or integrates the per-segment summaries into a global summary by applying a post-processing algorithm that removes redundancies and aligns topics. This non-conventional segmentation and distributed summarization approach reduces latency and memory consumption compared to feeding the entire transcript into a single large model invocation, thereby achieving improved scalability and throughput on the server.

The server performs conversion processing on the summary information to generate multilingual summary information. The server may use a separate neural machine translation model or may prompt a multilingual generative AI model directly. For example, when the original summary is in English and the user requests a Japanese version, the server constructs a secondary prompt sentence such as:
“Translate the following English summary into Japanese, maintaining the original meaning and bullet point structure. Summary: [English summary].”

The server passes this prompt sentence and the English summary to a translation model or to the same generative AI model configured for translation tasks. The translation model, which may be a transformer-based multilingual model, computes attention over language-specific embeddings and outputs translated tokens. By separating summarization and translation stages, the server reduces the computational load on any single model and enables reuse of specialized translation models. The server thereby provides consistent summaries in multiple languages without re-processing the original viewing medium data.

The server generates association information indicating correspondence between portions of the summary information and playback sections of the viewing medium data. During speech recognition, the server associates each character token or sentence with a start and end time relative to the audio component. During summarization, when the generative AI model selects or paraphrases key sentences, the server maintains a mapping between segments of the summary and the original source sentences. As a result, the server can compute, for each summary phrase or bullet point, one or more time intervals in the viewing medium data in which the corresponding information appears. The server stores this association information as a data structure, such as a list of tuples including a summary segment identifier and a time interval. When the terminal displays the summary information, the terminal may retrieve this association information to allow the user to select a summary item and initiate playback of the corresponding playback section. This tight coupling between summary representation and media timeline is not simply a human-perceived correspondence, but is encoded in machine-readable structures and used by the terminal to control a media playback engine.

The server transmits the summary information, multilingual summary information, and association information in a machine-readable format to the terminal. The server packages these data as structured messages including fields for language, content, formatting hints, and time indices. The terminal decodes the messages and renders the summary information on a display while concurrently controlling media playback. When the user selects a summary item displayed on the terminal, the terminal uses the associated time indices to send a playback control request to a media playback module. The terminal's media playback module then seeks to the corresponding timestamp in the viewing medium data and begins playback from that point. Consequently, the user can traverse large or complex viewing medium data non-linearly in accordance with the summary structure rather than manually scrubbing through the timeline, and the system reduces the amount of data that must be decoded and rendered to obtain relevant information.

The server stores the viewing medium data, the character information, the prompt sentence, and the summary information in association with identification information in a storage subsystem. The server uses a database management system or a structured storage layer to persistently store these entities as records that can be retrieved and reused. The identification information may include user identifiers, session identifiers, timestamps, and content type identifiers. Because the server retains the intermediate character information and prompt sentences, the server can later re-execute re-summarization processing or analysis processing without re-performing media separation and speech recognition. For example, the server may later construct a new prompt sentence such as:
“Rewrite the following summary to be suitable for an external press release, limiting the length to 150 words and using formal style. Original summary: [stored summary].”

The server then passes this new prompt and the stored summary to the generative AI model, generating a different form of summary for a different technical purpose without re-processing the underlying viewing medium data. This reuse of structured intermediates improves resource utilization and reduces redundant computation, thereby improving the functioning of the computer system as a whole.

In another embodiment, the server processes viewing medium data that is provided as sequential data, such as a real-time video stream or audio stream. The server receives segments of the sequential data over a streaming protocol and incrementally applies speech recognition and natural language processing to each temporal division. The server maintains a sliding window over recent character information and constructs prompt sentences that request an updated live summary. For example, for every new segment, the server may generate a prompt sentence such as:
“Provide a very short live summary of the following ongoing speech so far in English, in 3 bullet points or less. Focus on new information that has appeared in the last 2 minutes. Transcript so far: [partial transcript].”

The server passes this prompt and the partial transcript to the generative AI model and obtains an updated summary. The server then transmits the updated summary as update information to the terminal. The terminal displays the updated summary while the viewing medium data is being rendered, and the user can thus grasp the evolving content in real time. This incremental summarization and update mechanism requires specialized management of temporal divisions and partial transcripts in the server's data structures, and reduces latency compared to batch summarization at the end of the stream.

The server, in one embodiment, implements the generative AI model as a transformer-based neural network trained using supervised learning with a cross-entropy loss function on large text pairs consisting of original documents and corresponding human-written summaries. The server configures the model with multiple layers of multi-head self-attention, each with a specified number of attention heads and hidden dimensions, and applies positional encodings to represent token order. During training, the model parameters are updated using gradient-based optimization methods such as stochastic gradient descent with adaptive learning rates. The server may perform regularization techniques, such as dropout and label smoothing, and data augmentation such as random truncation of input or paraphrasing of target summaries. By using such a trained model rather than heuristic sentence selection, the server can generate summaries that capture deeper semantic relationships, including implicit cause-and-effect and multi-sentence context, thereby improving summary quality and coherence.

The server may, in other embodiments, use a fine-tuned version of an existing large language model that has been adapted specifically for summarization and translation tasks associated with viewing medium data. The server may supply example prompt sentences and target outputs during fine-tuning, and may bias the model towards generating outputs that include explicit temporal or structural cues. This fine-tuning allows the system to exploit model capacity more efficiently for the specific domain of multimedia content summarization.

The server improves computer technology in several ways. By integrating media separation, advanced speech recognition, structured natural language processing, dynamic prompt sentence construction, and generative AI summarization into a coordinated pipeline, the server reduces redundant data movement between components and avoids repeated decoding of the same data. By dividing long transcripts into segments and executing summarization in parallel over multiple processing units, the server reduces wall-clock processing time and facilitates real-time or near-real-time responses even for long viewing medium data. By generating association information that directly binds summary segments to time indices in the viewing medium data, the server enables the terminal to control a media playback device in a summarized, content-aware manner, reducing the volume of media that must be processed and displayed to reach relevant portions. By storing and reusing intermediate character information and prompt sentences, the server avoids re-running expensive speech recognition and media decoding, thereby reducing energy consumption, processing time, and storage bandwidth.

The server also implements non-conventional processing rules within the prompt management and segment integration modules. For example, the server may enforce a rule that each segment-level summary must introduce at least one unique key phrase not present in earlier segments, and the server may compute a similarity measure between candidate summaries and previously generated summaries to enforce diversity and avoid redundancy. The server may apply a rule that discards summary candidates that do not align with temporal distribution of topics inferred from the transcript. These rules use quantitative metrics—such as cosine similarity between sentence embeddings or coverage scores over key phrases—to filter model outputs before delivery to the terminal. Such procedures are distinct from human editorial work and rely on algorithmic evaluation and selection, resulting in improved precision and reduced noise in the delivered summaries.

In another variation, the server may use a hybrid architecture in which a smaller, faster generative AI model operates on short segments to produce candidate summaries, and a larger, more capable model refines or consolidates these candidates when computational resources are available. This tiered configuration allows the system to provide quick but approximate summaries in low-latency scenarios and higher-quality summaries for archival or analytical use, thereby adapting the computational complexity to the constraints of different use cases while maintaining consistent interfaces for the terminal and the user.

The terminal, in all embodiments, remains relatively simple in that it primarily captures viewing medium data, displays summary information and association information, and forwards playback control commands. The server performs the heavy processing using specialized software and models. As a result, the overall system provides a technical improvement over conventional multimedia viewing systems by enabling users to access, navigate, and understand large or streaming viewing medium data through structured, interactive, and multilingual summary information that is generated and managed using computer-implemented procedures designed specifically to enhance processing speed, accuracy, and resource utilization.

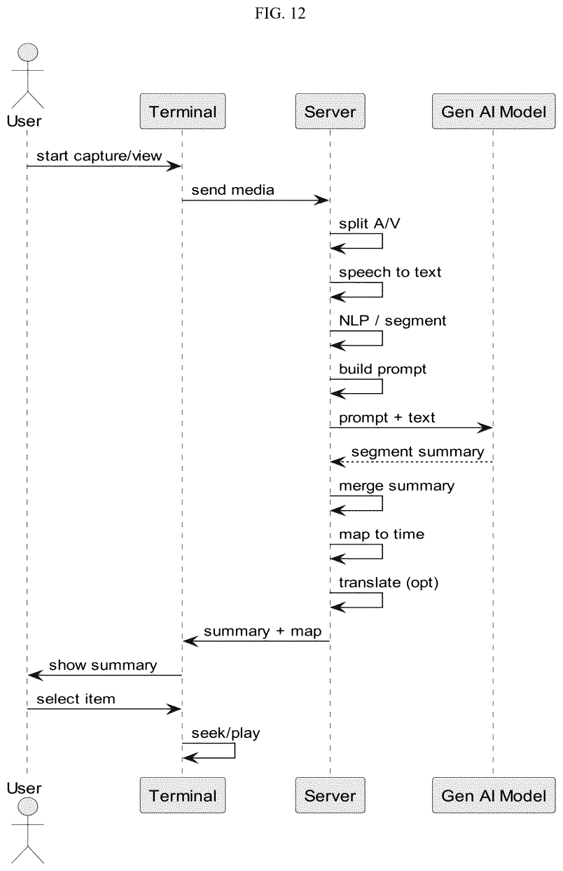

The following describes the processing flow using FIG. 12.

### Step 1:

The terminal acquires viewing medium data.

The terminal uses an imaging device and an audio input device to capture video and audio of content being recorded or viewed by the user. The terminal encodes raw sensor signals into a compressed multimedia file or stream (for example, using an OS-level media framework) and associates basic metadata such as creation time, duration, and media type.

Input: raw camera frames and audio samples from hardware sensors.

Processing: the terminal performs signal sampling, compression, and containerization to pack the audio and video into a standardized digital format.

Output: encoded viewing medium data and associated metadata ready to be transmitted to the server.

### Step 2:

The terminal transmits the viewing medium data to the server.

The terminal establishes a network connection to the server through a communication interface and sends the encoded viewing medium data using a protocol such as HTTPS or a streaming protocol.

The terminal may include user or session identifiers in a header or payload.

Input: encoded viewing medium data and metadata stored on the terminal.

Processing: the terminal segments the data into network packets, adds protocol headers, and performs encryption if required.

Output: a sequence of network messages carrying the viewing medium data and metadata to the server.

### Step 3:

The server receives and stores the viewing medium data.

The server accepts incoming network messages from the terminal using a network interface and reassembles them into the original viewing medium data. The server verifies integrity, associates the data with identification information, and stores the result in non-volatile storage.

Input: network messages containing the viewing medium data and metadata.

Processing: the server performs message parsing, error checking, and reconstruction of the multimedia container, and then writes the reconstructed data to a storage device while registering an entry in a storage index.

Output: stored viewing medium data referenced by an internal identifier and linked to session and user information.

### Step 4:

The server separates the viewing medium data into an audio component and a video component.

The server invokes a media decoding module that parses the container format, decodes stream headers, and extracts individual tracks. The server also builds a time index mapping between audio sample positions and video frame timestamps.

Input: stored viewing medium data identified by an internal identifier.

Processing: the server analyzes the container structure, reads multiplexed streams, demultiplexes them into separate audio and video data structures, and computes a mapping table of timestamps.

Output: an audio component as a time-series of audio samples, a video component as a sequence of video frames, and a timestamp mapping table.

### Step 5:

The server performs speech recognition processing on the audio component.

The server passes the audio component to a speech recognition engine that converts audio samples into a sequence of linguistic units. The engine generates a textual transcription in the form of character information and can additionally assign time codes to each word or sentence.

Input: audio component as a digitized waveform or time-frequency representation.

Processing: the server computes spectral features, feeds them into a trained neural network (for example, an acoustic and language model), estimates probabilities over linguistic units, and decodes the most likely sequence using a decoding algorithm such as beam search.

Output: character information representing a transcript of spoken content, annotated with timing information corresponding to the audio timeline.

### Step 6:

The server executes natural language processing on the character information.

The server uses a language processing module to transform the raw transcript into structured summarization target information. The server segments the text into sentences, tokenizes the sentences into tokens, and may add part-of-speech tags and other annotations.

Input: character information in the form of a raw transcript with optional timing data.

Processing: the server applies sentence boundary detection, tokenization, and linguistic tagging, removes noise such as repeated fillers, and organizes the results into a structured object (for example, a list of sentences with tokens and tags).

Output: summarization target information represented as structured text with sentence boundaries and linguistic annotations.

### Step 7:

The server segments the summarization target information when necessary.

The server determines whether the summarization target information is too long for a single invocation of the generative AI model and, if so, divides it into multiple portions based on sentence boundaries and length constraints. Each portion is assigned its own segment identifier and associated time range by using the timing data and the timestamp mapping table.

Input: summarization target information and associated timing metadata.

Processing: the server calculates the approximate token count for each sentence, groups sentences into segments under a threshold, and assigns start and end times for each segment based on the underlying audio and video timestamps.

Output: a set of summarization segments, each with segment-level text, sentence lists, and corresponding time ranges.

### Step 8:

The server constructs a prompt sentence for each summarization segment.

The server selects a prompt template based on content type (for example, news, lecture, meeting) and language, and then inserts the summarization segment text into the template. The server can adjust parameters such as requested number of bullet points or length of summary.

Input: summarization segment text, content type metadata, and language metadata.

Processing: the server concatenates instruction strings with the segment text, generates a well-formed prompt sentence such as “Summarize the key points of the following news report in English. Focus on what happened, who was involved, when and where it occurred, and what impact it has on society. Provide the answer in 5 short bullet points. Transcript: [segment text].”, and stores the result as a prompt object.

Output: one or more prompt sentences associated with respective summarization segments.

### Step 9:

The server invokes the generative AI model to generate summary information.

The server prepares input sequences for the generative AI model by tokenizing the prompt sentences and the corresponding segment text. The server then sends these token sequences to the generative AI model, optionally in parallel for multiple segments.

Input: tokenized prompt sentences and associated summarization segment text.

Processing: the generative AI model computes contextual embeddings via encoder layers, applies attention mechanisms to integrate prompt instructions with content, and generates output tokens through decoder layers with an autoregressive strategy. The server decodes the output tokens back into human-readable text and enforces formatting rules such as bullet points or maximum length.

Output: segment-level summary information as text strings that represent condensed descriptions of each summarization segment.

### Step 10:

The server integrates segment-level summaries into global summary information.

The server collects all segment-level summaries and merges them into an overall summary for the entire viewing medium data. The server may detect and remove redundant statements, re-order bullet points based on temporal order, and ensure consistent phrasing.

Input: multiple segment-level summary texts and their segment identifiers.

Processing: the server computes similarity between summary sentences, removes near-duplicates, orders remaining items according to segment time ranges, and concatenates them into a unified summary representation.

Output: global summary information representing the condensed content of the complete viewing medium data.

### Step 11:

The server generates association information between summary information and playback sections.

The server uses the segment identifiers and the timestamp mapping table to link each summary item to one or more time intervals in the audio and video streams. For finer granularity, the server may align particular phrases with specific sentences and their associated time spans.

Input: segment-level summary information, segment time ranges, and timestamp mapping table.

Processing: the server assigns each summary item a start time and end time based on the corresponding segment or source sentence times, and constructs a data structure (for example, a list of tuples) that associates summary item identifiers with playback time intervals.

Output: association information mapping summary items to playback sections of the viewing medium data.

### Step 12:

The server executes multilingual conversion on the summary information in response to user requests.

The server receives or determines target languages requested by the user and performs translation on the global summary information. The server may either call a translation model directly with the summary text or construct translation-specific prompt sentences.

Input: global summary information and a set of requested target language codes.

Processing: the server feeds the summary text into a translation engine or a multilingual generative AI model, which computes attention over multilingual vocabularies and generates translated text. The server ensures that list structures and bullet formats are preserved.

Output: multilingual summary information in the requested languages, linked to the same association information as the original summary.

### Step 13:

The server stores processing results with identification information.

The server writes the viewing medium data identifier, character information, summarization target information, prompt sentences, summary information, multilingual summary information, and association information to persistent storage. Each record is tagged with identification information such as user ID, session ID, and timestamps.

Input: all intermediate and final data objects generated by previous steps and identification metadata.

Processing: the server organizes the data into database tables or structured files, writes the data with appropriate indices, and updates references that allow future retrieval and re-summarization.

Output: a persistent record set that can be queried or reused for subsequent analysis or re-summarization operations.

### Step 14:

The server transmits the summary information and association information to the terminal.

The server packages the global summary information, any multilingual summary information, and the association information into a machine-readable message. The server sends this message over the communication network to the terminal as a response to the original request or as a streaming update.

Input: global summary information, multilingual summary information, and association information stored in memory.

Processing: the server serializes these data elements into a structured format, adds identifiers and language tags, and transmits the resulting message using the network interface.

Output: a network response message carrying summary and association data to the terminal.

### Step 15:

The terminal receives and displays the summary information.

The terminal parses the incoming message, extracts the summary information and association information, and updates the user interface. The terminal renders the summary as a list of bullet points or paragraphs and stores the association information in a local data structure used by the media player.

Input: network response message containing summary information and association information.

Processing: the terminal performs message deserialization, maps fields to UI elements, and binds each displayed summary item to its corresponding time interval using the association data.

Output: a displayed summary view on the terminal screen, with interactive elements linked to playback sections of the viewing medium data.

### Step 16:

The user interacts with the summary and controls playback.

The user reads the summary items on the terminal and selects specific items for more detailed viewing. The user may tap or click on a summary bullet, or select a language version of the summary, causing the terminal to trigger a playback control command.

Input: visual summary items and user input events such as taps, clicks, or gestures.

Processing: the terminal translates user input into selection commands, determines the associated playback section from the association information, and issues a seek or play command to the local media playback module or to a streaming controller.

Output: a media playback state in which the viewing medium data is repositioned to the selected playback section and begins or resumes playback.

### Step 17:

The server optionally performs re-summarization or additional analysis based on stored data.

The server receives a request to generate a different type of summary or to perform additional text analysis using previously stored character information and summary information. The server constructs a new prompt sentence tailored to the requested task, such as producing an executive summary or extracting action items only.

Input: stored character information, stored summary information, identification information, and a new summarization or analysis request.

Processing: the server retrieves the relevant text from storage, composes a new prompt sentence, tokenizes the text, and invokes the generative AI model or analysis engine, without re-executing media separation or speech recognition. The server then updates or creates new summary records and, if necessary, sends the results to the terminal.

Output: new summary or analysis results generated from existing stored data, reducing redundant computation and enabling flexible reuse of previously processed content.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional techniques for generating summaries from digital content, including audio and video content, generally rely on isolated components such as transcription engines, generic text summarizers, or translation services that are orchestrated in an ad hoc or manual manner. In such architectures, a processor typically forwards raw or minimally preprocessed data to separate services, and the interaction between services is not modeled as an integrated, state-aware workflow. As a result, the overall system exhibits several technical shortcomings in terms of computer technology.

First, existing systems often lack an integrated control mechanism for constructing and managing prompt sentences to be supplied to a generative AI model. Prompt construction is frequently performed on the client side or by static templates, without dynamic incorporation of recognized character information, summarization conditions, and user feedback. This leads to inefficient use of computing resources in the generative AI model, redundant processing, and inconsistent output quality. The absence of centrally managed prompt sentences also makes it difficult for the system to reuse prior computation results or to trace and refine prior processing for the same input information.

Second, conventional systems do not maintain a unified processing state across multiple stages such as audio extraction, transcription, summarization, user correction, translation, and distribution. Without a processor-managed state model and associated state information, a user terminal must repeatedly poll or reconstruct status from partial responses, leading to increased network traffic, duplicated processing, and poor observability. In distributed environments where the transcription service, the generative AI model, and the translation resource are separate computing resources, lack of orchestrated state tracking can cause inconsistent states, partial failures, or unnecessary re-execution of prior steps.

Third, in many known approaches, user correction of summary information is decoupled from the core processing pipeline. The corrected summary is often treated merely as a final document, not as structured data linked to the original input information, prompt sentences, and intermediate results. Consequently, subsequent translation or re-summarization steps cannot effectively leverage the corrected summary as a higher-quality input, and the system cannot systematically reuse corrected data in later workflows. This degrades the technical efficiency of subsequent processing and wastes computational resources by repeating similar inference tasks on suboptimal data.

Fourth, existing summarization systems have difficulty handling long-duration digital information in a scalable and resource-efficient manner. A naive approach is to send the entire long-duration transcript as a single prompt to the generative AI model. This approach is constrained by input size limitations of the model, incurs high latency, and can generate unstable or incomplete summaries due to context overload. While some systems perform rudimentary segmentation, they often lack an integrated mechanism to generate segment-level prompt sentences, execute parallel calls to the generative AI model, and integrate multiple segment-level summary information items into a coherent overall summary in a state-aware manner.

Fifth, multilingual dissemination is typically handled as an optional post-processing step that is loosely connected to the summarization pipeline. Translation services may receive arbitrary user-provided text without any linkage to the underlying prompt sentences or summary versions used during summarization. This lack of linkage prevents the system from systematically managing versions of summary information and translation information for each piece of input information. As a result, users cannot reliably track which version of the summary was used for which translation, and the server cannot efficiently provide reusable resources for subsequent processing requests involving the same or related input information.

Accordingly, there is a need for an improved computer-implemented system and server architecture that (i) centrally manages the generation and use of prompt sentences for a generative AI model, (ii) maintains structured associations between input information, character information, summary information, corrected summary information, and translation information, (iii) explicitly manages state information and progress status for multi-stage processing, (iv) supports parallel, segment-based processing of long-duration digital information to generate integrated overall summary information, and (v) enables reuse of prior computation results in subsequent workflows. Such an architecture should improve the efficiency, scalability, reliability, and observability of summary generation and multilingual distribution at the level of computer technology, rather than merely automating manual document preparation tasks.

The specific processing by the specific processing unit 290 of the data processing device 12 in Example 2 is realized by the following means.

The present invention provides a server comprising a processor configured to receive digital information including audio information as input information and generate character information from the audio information, generate a prompt sentence including summarization conditions and the character information, input the prompt sentence into a generative AI model, and cause the generative AI model to generate summary information on the basis of the character information, cooperate with a user terminal to accept a correction operation by a user with respect to the summary information, acquire corrected summary information from the user terminal, and store the corrected summary information, transmit the corrected summary information to an information processing resource having a translation processing function and acquire translation information in a plurality of languages, provide information including at least one of the summary information, the corrected summary information, and the translation information to the user terminal via a communication network, store, in association with the input information, at least the prompt sentence, the summary information, and the translation information, and manage the stored information so as to be reusable in subsequent processing for the input information, and generate state information indicating a processing state of the input information and transmit the state information to the user terminal so that a progress status is displayable on the user terminal. This enables an integrated, state-aware workflow in which the server centrally constructs and manages prompt sentences for the generative AI model, orchestrates multi-stage processing including transcription, summarization, user correction, and translation, maintains structured associations among input information and multiple types of derived information, executes scalable segment-based and parallel processing for long-duration content, and reuses prior computation results to improve computing efficiency, scalability, and reliability of summary generation and multilingual distribution in a computer-implemented environment.

The term “server” refers to an information processing apparatus including at least one processor and a memory, the apparatus being configured to execute programs for performing reception, analysis, transformation, storage, and transmission of information via a communication network.

The term “processor” refers to a hardware computation element, such as a central processing unit or a processing core, configured to execute instructions that cause the server to perform the functions described in the present specification and claims.

The term “digital information” refers to information represented in an electronic form, including but not limited to audio data, video data, text data, and metadata, that is processable by the server.

The term “audio information” refers to a component of digital information representing sound, including spoken words, that can be subjected to speech recognition processing to generate character information.

The term “video information” refers to digital information including a time-series of image frames, optionally combined with audio information, that can contain public information or explanatory information such as presentations, announcements, or lectures.

The term “character information” refers to information expressed as a sequence of characters or symbols, including text generated by converting audio information into text by a speech recognition process.

The term “input information” refers to digital information supplied to the server as a basis for subsequent processing, including at least audio information, video information, or character information received from an external device or storage.

The term “public information” refers to information intended for disclosure to an audience, including but not limited to official announcements, reports, briefings, and similar materials.

The term “explanatory information” refers to information that explains, describes, or clarifies a topic, including presentations, speeches, tutorials, and other narrative content.

The term “prompt sentence” refers to a sequence of characters that includes an instruction or condition for processing, such as summarization conditions, and that is supplied as input to a generative AI model together with or in combination with character information.

The term “summarization conditions” refers to one or more constraints or parameters used in generating summary information, including desired length, style, level of detail, target audience, and focus topics.

The term “generative AI model” refers to a computational model, such as a probabilistic or neural network-based language model, configured to generate output text including summary information in response to input comprising at least a prompt sentence and character information.

The term “summary information” refers to information generated by the generative AI model or by other processing based on character information, the information representing a condensed form of the content of the input information while preserving essential points.

The term “corrected summary information” refers to summary information that has been modified based on a correction operation performed by a user, and that is stored as an updated version of the summary information.

The term “user terminal” refers to an information processing device operated by a user, such as a computing device or communication device, configured to communicate with the server via a communication network to display information, accept user input, and transmit user operations to the server.

The term “correction operation” refers to an operation performed by a user via the user terminal to modify, edit, or revise summary information, including operations such as adding, deleting, or changing characters or phrases.

The term “information processing resource having a translation processing function” refers to a hardware or software resource, local or remote, configured to execute translation processing that converts character information expressed in a first language into character information expressed in at least one second language.

The term “translation information” refers to character information obtained as a result of translation processing that converts text from a source language into one or more target languages.

The term “plurality of languages” refers to two or more natural languages that are distinct from one another, such as different human languages used for communication.

The term “communication network” refers to an electronic communication infrastructure, such as a wired or wireless network, including public or private networks, through which the server and the user terminal exchange information.

The term “state information” refers to information indicating at least one stage, status, or progress condition of processing performed by the server on input information, including statuses such as reception, transcription, summarization, correction, translation, or completion.

The term “progress status” refers to a representation of a current or historical state of processing for input information, derived from state information, and displayable on the user terminal to inform a user of processing advancement.

The term “long-duration digital information” refers to digital information whose time length or data size exceeds a predetermined threshold, such that direct summarization as a single input to a generative AI model is impractical or inefficient.

The term “segment information” refers to a portion of long-duration digital information obtained by dividing the long-duration digital information based on time, size, or logical boundaries, each portion being processable independently.

The term “overall summary information” refers to summary information generated by integrating or combining a plurality of summary information items respectively corresponding to a plurality of segment information items of long-duration digital information.

The term “subsequent processing” refers to processing executed after an initial processing for given input information, including re-summarization, additional translation, refinement, or other operations that reuse previously stored prompt sentences, summary information, or translation information.

The term “reusable” refers to a property by which stored information such as prompt sentences, summary information, and translation information can be recalled and used again in subsequent processing for the same or related input information without re-executing at least part of the original computation.

In one embodiment, a server includes at least one processor, a memory, a non-transitory storage device, and a network interface. The server executes programs that implement a pipeline comprising audio extraction, speech recognition, text preprocessing, prompt sentence construction, interaction with a generative AI model, summary information management, user correction handling, translation, and state tracking. The server communicates with a terminal operated by a user via a communication network such as the Internet or an intranet.

The server uses general-purpose computing hardware such as a multi-core central processing unit and, in some embodiments, one or more graphics processing units or tensor processing units to accelerate inference of a generative AI model. The memory stores executable program instructions and data structures including job records, transcript data, prompt sentences, summary information, corrected summary information, translation information, and state information. The storage device stores long-term data including audio files, video files, and log data. The network interface sends and receives information using communication protocols such as HTTP or HTTPS.

The server obtains digital information including audio information. In one example, the server receives video information of a financial results presentation, a public briefing, or another explanatory session from the terminal. The terminal runs a web browser application that allows the user to select a video file from local storage and upload it to the server over a secure connection. The server writes the received stream to storage and, in some embodiments, transfers the stored data to a remote storage resource such as a cloud object storage service for durability and scalable access.

The server uses media processing software such as a command-line media processing tool or a media processing library to parse the video container and extract audio information. The server reads container headers, determines available audio tracks, and selects a track according to predefined rules (for example, a track with the highest bitrate or a track labeled with a particular language code). The server converts the audio information to a standardized format, such as linear PCM at a fixed sample rate and channel configuration, to provide uniform input to a speech recognition component. This standardized format improves recognition accuracy and simplifies downstream processing because subsequent modules can assume consistent sampling parameters and encoding.

The server supplies the audio information to a speech recognition system. In one embodiment, the server calls a remote speech recognition service through an application programming interface and passes a uniform resource identifier of the stored audio file. In another embodiment, the server uses a local speech recognition engine. The speech recognition system applies acoustic modeling and language modeling to map acoustic feature sequences to character sequences. Acoustic modeling may use a neural network such as a deep convolutional network or a recurrent network that consumes spectrogram features, and language modeling may use an n-gram model or a transformer-based model to assign probabilities to candidate symbol sequences. The server receives recognition results including recognized text and timing and confidence metadata in a structured format, and the server transforms these results into character information.

The server preprocesses the character information before constructing a prompt sentence. The server may normalize punctuation, unify number formats, and segment the character information into logical units such as sentences or paragraphs based on pause durations and punctuation marks. The server optionally applies a natural language processing toolkit or an in-house segmentation algorithm to identify topic boundaries and label segments with topic identifiers. By producing structured character information in this way, the server can later construct prompt sentences that selectively include segments relevant to specified summarization conditions, thereby reducing the amount of data sent to the generative AI model and decreasing computational load.

The server generates a prompt sentence for a generative AI model. The server maintains a prompt template that contains natural language instructions and special tokens to be filled with context-specific values, such as desired length, target audience, and focus topics. The server dynamically populates the template using metadata and user-specified preferences. For example, when the user selects an “executive summary” mode, the server inserts phrases that instruct the generative AI model to prioritize high-level key performance indicators and business implications.

In one concrete example, the server constructs the following prompt sentence:
“You are a financial analyst. Read the following transcript of a 2023 Q3 earnings call and create a concise summary (about 300 words) focusing on revenue, profit, key business drivers, and future outlook. Use clear and professional business English.

### Transcript:

[transcribed text here]”

In another example, when the user targets non-specialist employees, the server constructs a different prompt sentence:
“Summarize the Q3 2023 earnings presentation for non-specialist employees in about 5 bullet points, highlighting what changed compared to the previous quarter and what actions the company plans to take.”

The server inputs the prompt sentence and the associated character information into the generative AI model. In one embodiment, the generative AI model is a transformer-based neural network trained as a language model on large-scale text corpora. The model includes a stack of self-attention layers, each layer computing attention scores between tokens to capture contextual relationships. The server tokenizes the prompt sentence and the character information according to a subword tokenization scheme and passes token identifiers to the model. The model maintains parameter matrices (weights) for query, key, and value projections, feedforward networks, and layer normalization components. During inference, the model computes attention distributions, intermediate hidden states, and output logits for each token position.

The server configures the generative AI model with decoding parameters such as temperature, top-k cutoff, or nucleus sampling threshold to balance determinism and diversity. The server uses logit biasing or constrained decoding rules to suppress undesired patterns (for example, overly long introductions) and to encourage output structures such as bullet lists when requested by summarization conditions. This configuration results in more stable and predictable summary information and reduces the need for repeated re-generation.

The server receives output tokens from the generative AI model and reconstructs them into summary information as a character sequence. The server stores the summary information along with the corresponding prompt sentence, the identifiers of the generative AI model version, and associated input information identifiers. By storing these associations, the server can later reuse the summary information or reconstruct the context under which the summary was generated. This structured storage forms a specialized data structure that links input information, processing parameters, and outputs, which improves traceability and reproducibility and supports efficient re-processing without repeating all computational steps.

The terminal presents the summary information to the user. The terminal displays the summary in an editable user interface element and may also display associated state information such as the processing stage and timestamps. The user reviews the summary, detects domain-specific inaccuracies or preferences, and performs a correction operation using input devices such as a keyboard or pointing device. The terminal transmits the corrected text to the server as corrected summary information.

The server stores the corrected summary information as a new version in a storage structure that tracks both the original summary information and user-modified versions. The server maintains version identifiers and associates them with their respective prompt sentences and timestamps. This versioned storage enables the server to select an appropriate summary for subsequent translation or for new prompt sentence generation. Because corrected summary information reflects domain expertise, subsequent processing steps use this corrected summary as input, thereby improving accuracy and reducing redundant computation compared to systems that always rely on raw character information.

The server transmits the corrected summary information to an information processing resource that performs translation processing. In one embodiment, the server calls a neural machine translation service, which uses an encoder-decoder architecture with attention to map source-language character information to one or more target languages. In another embodiment, the server uses a local translation model. The server specifies the source language and a set of target languages and may also specify style parameters such as formality level. The translation resource produces translation information for each target language, and the server stores this translation information in association with the corresponding corrected summary information.

The terminal allows the user to select target languages, view translations side-by-side with the source summary, and perform minor edits if desired. The server may further refine translation information by invoking the generative AI model with a prompt sentence designed for style polishing, such as:
“Polish the following English summary for clarity and professional tone without changing any factual content.”

In this case, the server passes the translation information as context following the prompt sentence, and the generative AI model produces a revised version that corrects minor phrasing issues while preserving the original meaning. The server stores both the original and refined translation information with appropriate metadata to indicate their relationship.

In another embodiment, the server processes long-duration digital information by dividing it into segment information. The server uses segmentation criteria such as fixed time windows, detected topic boundaries, or content-based markers such as slide changes in a presentation. For each segment, the server generates segment-level character information and constructs a segment-level prompt sentence. The server then sends multiple prompt sentences and their associated character information segments to the generative AI model in parallel. Parallelization is performed by distributing requests across multiple processing threads or nodes and may also exploit hardware concurrency in accelerator devices. This design reduces wall-clock time compared to serial processing and makes effective use of computational resources, particularly for lengthy content.

The server receives segment-level summary information from the generative AI model and integrates the multiple segment-level summaries into overall summary information. The server can apply a second-level summarization step in which the server constructs an additional prompt sentence that instructs the generative AI model to synthesize the segment-level summaries into a coherent whole. In another variation, the server uses rule-based merging, arranging segment-level summaries in chronological order and eliminating redundancy by comparing n-gram overlap. These integration steps are implemented as explicit algorithms operating on data structures that represent segments and their summaries, leading to more predictable and efficient behavior than ad hoc manual combination.

The server generates and maintains state information for each piece of input information. The server defines a finite set of states such as “received,” “audio extracted,” “transcribed,” “summarized,” “correction pending,” “corrected,” “translated,” and “completed.” The server updates state information in a dedicated state table whenever a processing stage finishes successfully or fails. This state information is transmitted to the terminal, enabling the terminal to display progress status without reconstructing processing state from raw logs. By providing explicit state tracking, the server avoids unnecessary repetition of completed steps, can resume interrupted processing from intermediate states, and can schedule resources more efficiently.

The described architecture improves computer technology in several ways. By standardizing audio formats and segment structures before recognition and summarization, the server reduces variability in input to downstream components, leading to improved accuracy and reduced need for redundant retries. By centrally constructing and managing prompt sentences based on structured character information and explicit summarization conditions, the server efficiently controls the behavior of the generative AI model, reducing the number of model invocations and token computations necessary to reach a desired quality level. By storing prompt sentences, intermediate results, and associations in a specialized data structure, the server enables reuse of prior computation in subsequent processing, which saves processing cycles, reduces latency, and lowers communication overhead.

Furthermore, by dividing long-duration digital information into segment information and performing parallel summarization, the server overcomes input size and latency limitations of generative AI models and achieves scalable handling of large input data. This segmented, parallel approach is not a simple automation of human reading and summarization but a computational scheme that exploits hardware parallelism and data structures tailored for machine processing. The explicit state model and progress tracking reduce unnecessary network traffic because the terminal does not need to request or recompute entire processing pipelines; instead, it queries and displays compact state information.

In one variation, the server stores learned adjustment parameters that modify decoding configurations for specific users or content types. For example, if past processing for a particular user has shown that shorter summaries with lower temperature produce better usable results, the server can record this as user-specific metadata and adjust future prompt sentences and decoding parameters automatically. This adaptive configuration improves both output quality and computational efficiency.

In another variation, the server uses a local generative AI model tuned on domain-specific data for particular industries, such as financial reporting or technical documentation. The server performs fine-tuning of the generative AI model by using supervised learning on pairs of transcripts and expert-written summaries. During training, the server minimizes a loss function such as cross-entropy between predicted tokens and ground-truth tokens, updating model weights using an optimization algorithm such as stochastic gradient descent with adaptive moment estimation. This training process results in a model that generates more accurate and focused summaries, reducing manual correction burden and further decreasing downstream computational load because fewer iterations of re-generation are required.

The terminal and the server cooperate to provide a user interface and an underlying processing pipeline that are tailored to the characteristics of generative AI models and speech recognition systems. The user is not required to manually orchestrate interactions between separate engines or maintain detailed logs of processing steps. Instead, the server encodes processing decisions into structured data and algorithms, resulting in an architecture that fundamentally changes how large volumes of audio and video content are processed at scale. This leads to measurable technical effects such as reduced processing time for large datasets, improved accuracy of summaries and translations due to integrated use of corrected summary information, and reduced network and computational overhead through reuse of stored intermediate results.

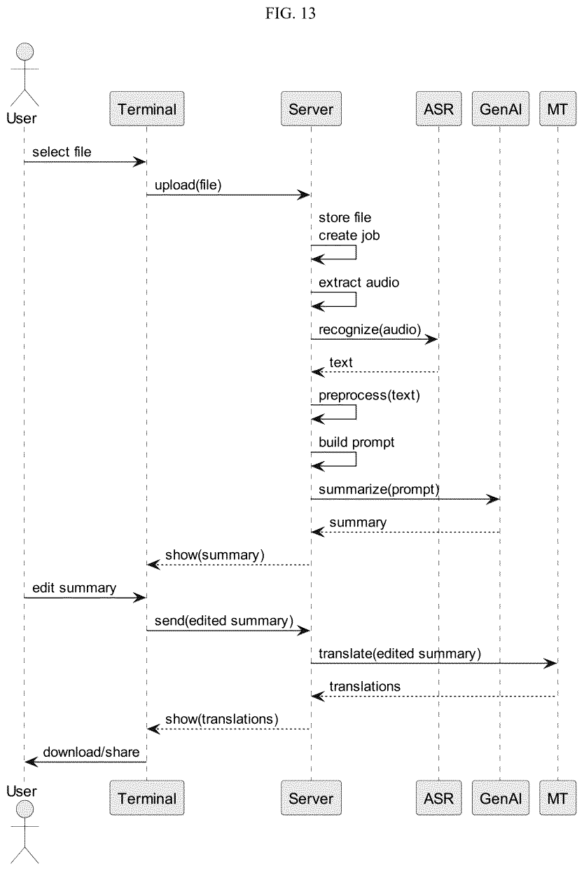

The following describes the processing flow using FIG. 13.

### Step 1:

The terminal sends input information to the server.

The terminal accepts a selection operation by the user for a digital file such as video information or audio information from local storage. The terminal generates an upload request including metadata such as file name, file size, and content type, and transmits the digital file to the server via a communication network using a protocol such as HTTPS. The input of this step is the raw digital file on the terminal, and the output is a binary data stream received by the server. The terminal displays an upload progress indicator by calculating the ratio of transmitted bytes to total bytes and updating the indicator based on acknowledgments from the server.

### Step 2:

The server stores the digital information and registers a processing job.

The server receives the binary data stream from the terminal and writes the stream into a temporary storage area on a storage device. The server then moves or copies the completed file into a designated content storage area and generates a job identifier in a job management table in a database. The input of this step is the received binary data stream, and the output is a stored digital file and a structured job record containing references to the file location, user identifier, upload time, and requested processing options. The server also initializes state information for the job, setting the state to a value such as “received.”

### Step 3:

The server extracts audio information from the digital information.

The server reads the stored digital file and analyzes its container format using media processing software. The server parses headers to identify audio tracks, selects a primary audio track based on predefined rules, and decodes the selected audio track into a standardized format, such as pulse-code modulated audio at a fixed sampling rate and channel configuration. The input of this step is the stored digital file, and the output is an audio file in the standardized format. The server updates the job record with the path to the audio file and changes the state information to indicate that audio extraction is completed.

### Step 4:

The server generates character information by performing speech recognition.

The server supplies the standardized audio file to a speech recognition component, either locally or via a remote speech recognition service. The server segments the audio into frames, computes acoustic features such as Mel-frequency cepstral coefficients, and transmits either the raw audio or extracted features to an acoustic model. The acoustic model maps features to phonetic representations, and a language model resolves likely word sequences. The input of this step is the standardized audio file, and the output is character information including recognized text and optional timestamps and confidence values. The server stores the character information in a transcript table and sets state information to “transcribed.”

### Step 5:

The server preprocesses the character information.

The server analyzes the character information to normalize its format and structure. The server replaces irregular whitespace, standardizes number formats, and inserts punctuation where omitted by the speech recognition component when possible. The server segments the character information into sentences and paragraphs by applying rules based on punctuation and time gaps in timestamps. The input of this step is the raw character information from speech recognition, and the output is preprocessed character information with defined boundaries and normalized symbols. The server updates the transcript record to include segmentation data and prepares the data for efficient prompt sentence construction.

### Step 6:

The server constructs a prompt sentence for a generative AI model.

The server reads user preferences and system defaults for summarization conditions, such as target length, target audience, focus topics, and output format (for example, bullet list or narrative). The server retrieves a prompt template stored in configuration data and fills template placeholders with the summarization conditions and relevant segments of the preprocessed character information. The input of this step is the preprocessed character information and the summarization conditions, and the output is a complete prompt sentence that includes instructions for summarization and the text to be summarized. The server stores the prompt sentence as a record linked to the job and transcript identifiers.

### Step 7:

The server generates summary information by interacting with the generative AI model.

The server tokenizes the prompt sentence and associated character information using a tokenizer compatible with the generative AI model, converting text into token identifiers. The server sends these token identifiers and decoding parameters such as maximum token length, temperature, and sampling strategy to the generative AI model. The generative AI model computes attention scores and hidden representations layer by layer and produces output token probabilities; the server iteratively selects tokens according to the decoding parameters to generate the summary text. The input of this step is the prompt sentence and associated character information, and the output is summary information in textual form. The server stores the summary information in a summary table and sets state information to “summarized.”

### Step 8:

The terminal presents the summary information to the user.

The terminal requests summary information and state information for the job from the server. The server responds with the latest summary information and associated metadata such as length, creation time, and model identifier. The terminal renders the summary information in an editable display area and may highlight detected entities or numbers for review. The input of this step is the summary information and metadata received from the server, and the output is a visual representation of the summary on the terminal's display. The terminal may also show progress indicators based on the state information.

### Step 9:

The user performs a correction operation on the summary information.

The user reads the presented summary information on the terminal and identifies parts that should be modified, such as numerical details, terminology, or style. The user inputs changes through the terminal, for example by selecting text and typing revised content. The input of this step is the displayed summary information, and the output is corrected summary information as edited text within the terminal interface. The terminal captures the final edited content when the user issues a confirmation operation, such as pressing a save button.

### Step 10:

The terminal transmits corrected summary information to the server.

The terminal packages the corrected summary information together with the job identifier and sends it to the server via a communication interface. The terminal may also include a change description or version note if requested. The input of this step is the corrected summary information on the terminal, and the output is a network request containing the corrected summary information received by the server. The terminal updates its display to indicate that the corrected summary is being saved.

### Step 11:

The server stores and versions the corrected summary information.

The server receives the corrected summary information and compares it with the original summary information to compute differences, such as added or removed text segments. The server generates a new version record for the corrected summary information, assigns a version identifier, and stores the corrected content in a summary version table linked to the job and the original summary. The input of this step is the corrected summary information from the terminal, and the output is a persisted, versioned corrected summary record. The server updates state information to “corrected” and may log the correction event.

### Step 12:

The server performs translation processing on the corrected summary information.

The server reads the corrected summary information and the list of target languages specified for the job. The server sends the corrected summary to a translation resource, either a remote translation service or a local neural machine translation model, including source-language identification and target-language codes. The translation resource encodes the source text into a latent representation and decodes it into target-language text using an encoder-decoder architecture. The input of this step is the corrected summary information and target-language list, and the output is translation information, comprising translated texts for each target language. The server stores the translation information in a translation table associated with the corrected summary version and updates state information to “translated.”

### Step 13:

The terminal displays translation information to the user.

The terminal requests translation information for the job from the server after state information indicates that translation is finished. The server returns the translation information with language codes and any style attributes. The terminal displays the translations in a selectable interface, such as tabs or a list, and may allow side-by-side comparison with the corrected summary information in the source language. The input of this step is the translation information from the server, and the output is the rendered translations on the terminal display for user review and optional minor adjustments.

### Step 14:

The server generates downloadable files and sharing resources.

The server receives a request from the terminal specifying desired output formats, such as structured text, document files, or presentation notes. The server compiles the corrected summary information and translation information into formatted content, applies layout and encoding rules, and invokes document generation libraries to create files. The input of this step is the corrected summary information, translation information, and format specification, and the output is one or more files or resources stored in content storage with associated access paths. The server updates job metadata to include references to these resources and, if requested, sends notification data to the terminal indicating that the resources are ready.

### Step 15:

The terminal downloads or distributes the generated resources.

The terminal retrieves a list of available resources for the job, including file types, languages, and links, from the server. The terminal initiates download operations for selected resources, storing them on local storage, or instructs the server to distribute resources via external channels such as email or collaboration platforms. The input of this step is the resource list and links provided by the server, and the output is the transfer of concrete files or messages to destinations chosen by the user. The terminal may display completion messages and maintain a local record of what has been downloaded or distributed.

### Step 16:

The server maintains and updates state information and reusable records.

The server continuously updates state information as each major processing phase completes, writing state changes to a dedicated state table. The server also preserves associations among input information, prompt sentences, summary information, corrected summary information, and translation information in structured records. The input of this step is internal event data indicating the completion or failure of processing tasks, and the output is updated state records and linked data structures that can be referenced by future processing requests. The server uses these records to avoid redundant computations when similar input information is processed again, thereby improving computational efficiency and reducing network and processing load.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer systems that perform text summarization and translation mainly operate on static text data and rely on fixed, manually designed rules or simple model calls. Such systems typically accept a block of text, invoke a summarization engine once, and then optionally pass the result to a translation engine. These architectures are not optimized for heterogeneous digital information that includes mixed audio and visual streams, they do not scale well to long-duration content such as multi-hour presentations or continuous broadcasts, and they provide only limited or no adaptation to user-specific context or user emotion.

In particular, existing summarization pipelines exhibit several technical deficiencies. First, when handling long-duration audio-visual information, many systems either truncate input or perform naive chunking without coordinated aggregation, which leads to loss of important information, redundant output, and inefficient use of computational resources. Second, existing systems often treat summarization and translation as separate, loosely coupled steps implemented at the application layer, without a processor-level control flow that systematically manages prompt construction, model invocation, and result storage in a unified way. This results in unnecessary network traffic, repeated calls to remote models, and increased end-to-end latency.

Third, conventional solutions generally do not incorporate user attribute information or emotion information as first-class inputs to the summarization process. When emotion recognition is used at all, it is often handled outside the summarization pipeline and does not dynamically influence the generation of prompt sentences or the behavior of the models. As a result, the generated summaries are insensitive to individual users'reactions, are not adapted to the user's level of understanding, and do not optimize the user interface latency or content relevance.

Fourth, many systems lack an integrated mechanism for generating visual auxiliary information (such as diagrams or illustrative images) in coordination with textual summaries. In such systems, any visual generation is decoupled from the summarization flow, so visual outputs may be inconsistent with the textual summaries or may require additional manual configuration and separate processing.

From the perspective of computer technology, these limitations manifest as inefficient utilization of processing resources, sub-optimal orchestration of multiple machine-learned models, fragmented data management across storage and network interfaces, and increased latency and bandwidth consumption in providing summaries to user terminals. There is a need for a computer-implemented system that improves the way a processor controls acquisition, segmentation, prompt sentence generation, multi-stage generative AI model invocation, multilingual translation, emotion-aware adjustment, and visual auxiliary generation in an integrated and automated manner. Such a system should technically improve the functioning of servers, networks, and model-based processing pipelines by reducing redundant processing, structuring parallel and hierarchical summarization, and dynamically tailoring processing parameters to user-specific and emotion-specific context.

The specific processing by the specific processing unit 290 of the data processing device 12 in Application Example 2 is realized by the following means.

The present invention provides a server comprising a processor configured to acquire digital information including at least acoustic information and/or visual information, to extract character information from the acoustic information and/or the visual information, to generate, based on the character information and on user attribute information and/or emotion information associated with the digital information, a prompt sentence that defines parameters of summarization processing including a summarization content, an output format, an output language, and a degree of adaptation to emotion, to input the prompt sentence and the character information into a generative information processing model and cause the generative information processing model to generate summary information of the character information and emotion-adjusted summary information adjusted according to the emotion information, to input the summary information into a translation processing apparatus and cause the translation processing apparatus to generate multilingual summary information in a plurality of languages, to store the summary information, the multilingual summary information, and the emotion-adjusted summary information in association with each other in an information storage apparatus, to transmit at least one of the summary information, the multilingual summary information, and the emotion-adjusted summary information to a user information processing terminal via an information communication network, and to generate a visual-generation prompt sentence for generating visual auxiliary information corresponding to content of the digital information, input the visual-generation prompt sentence into an image generation processing apparatus to cause the image generation processing apparatus to generate the visual auxiliary information, and transmit a generation result of the visual auxiliary information to the user information processing terminal. This enables the server to implement an integrated, processor-controlled summarization pipeline that automatically converts heterogeneous digital information into coherent text summaries and coordinated visual auxiliaries, to perform scalable parallel and hierarchical summarization with controlled prompt sentences, to reduce computational and network overhead through structured reuse and storage of multilingual and emotion-aware outputs, and to adapt the generated summaries in real time to user-specific attributes and emotion states, thereby improving the technical performance of the information processing system as a whole.

The term “digital information” refers to information represented in an electronic format, including at least one of acoustic information, visual information, and character information, and suitable for processing by an information processing apparatus.

The term “acoustic information” refers to information encoded as audio signals, such as speech, sound, or other audible content, that can be processed by a sound input/output apparatus or a speech recognition apparatus.

The term “visual information” refers to information encoded as image or video data, including moving images and still images, that can be processed by an image input/output apparatus or an image recognition apparatus.

The term “character information” refers to information represented in a symbolic text format, such as letters, numerals, and punctuation, obtained by converting acoustic information or visual information into textual data or by directly receiving textual data.

The term “user attribute information” refers to information indicating characteristics of a user, including at least one of a language preference, a region, a role, a level of expertise, a device type, and a usage history, that can be used to control processing performed by a processor.

The term “emotion information” refers to information indicating an emotional state of a user, such as joy, excitement, confusion, boredom, or sadness, derived from sensor data, behavioral data, or explicit user input, and usable as a parameter for adaptation of processing.

The term “prompt sentence” refers to a sentence or group of sentences in natural language that specifies an instruction or a set of constraints for a generative information processing model, including at least one of a requested task, a summarization granularity, an output format, an output language, and an adaptation policy.

The term “generative information processing model” refers to a machine-learned model that receives as input a prompt sentence and associated information and that generates, as output, new information including at least one of summary information, emotion-adjusted summary information, and visual-generation prompt sentences.

The term “summary information” refers to information obtained by compressing character information through extraction or abstraction of important elements, such that the overall content is represented in a shorter and more concise form.

The term “emotion-adjusted summary information” refers to summary information whose content, emphasis, or expression has been modified in accordance with emotion information so as to reflect a user's emotional state or to adapt to the user's reaction.

The term “translation processing apparatus” refers to a functional unit, implemented by hardware, software, or a combination thereof, that converts input text in a first language into output text in one or more second languages.

The term “multilingual summary information” refers to a set of pieces of summary information representing substantially the same summarized content in a plurality of different natural languages.

The term “information storage apparatus” refers to a storage subsystem, including at least one of a semiconductor memory, a magnetic storage medium, and an optical storage medium, that stores information such as character information, summary information, and multilingual summary information in an addressable manner.

The term “information communication network” refers to a communication infrastructure that interconnects a server and one or more user information processing terminals by wired or wireless links, and that supports transmission and reception of data packets or messages.

The term “user information processing terminal” refers to an information processing device operated by a user, including at least one of a portable information terminal, a stationary computer, a wearable display device, and a head-mounted display device, that can communicate with a server and present information to the user.

The term “visual auxiliary information” refers to visual information, such as diagrams, charts, illustrations, icons, or images, that is generated so as to complement or explain content of summary information or digital information.

The term “visual-generation prompt sentence” refers to a prompt sentence that specifies instructions for generating visual auxiliary information, including at least one of a requested visual style, data values to be depicted, and semantic emphasis.

The term “image generation processing apparatus” refers to a functional unit, implemented by hardware, software, or a combination thereof, that receives a visual-generation prompt sentence and generates visual auxiliary information in the form of image data.

The term “public announcement information” refers to digital information that corresponds to official statements, financial disclosures, press releases, or similar communications intended for broad public distribution.

The term “explanatory information” refers to digital information that explains concepts, operations, procedures, or data, such as manuals, tutorials, or technical explanations.

The term “educational information” refers to digital information used for learning or instruction, such as lectures, training materials, course content, or instructional videos.

The term “entertainment information” refers to digital information intended primarily for enjoyment or leisure, such as movies, drama programs, sports broadcasts, and variety programs.

The term “news information” refers to digital information providing reports about events, conditions, or topics of public interest, such as news broadcasts, news articles, or current-affairs programs.

The term “summarization granularity” refers to a level of detail requested for summary information, including at least one of a number of words, a number of sentences, a number of points, or a conceptual depth.

The term “expression format” refers to a structural style of output information, including at least one of bullet-point format, paragraph format, headline format, and question-and-answer format.

The term “emphasis items” refers to particular aspects, topics, entities, or metrics that are designated to be highlighted or prioritized during generation of summary information.

The term “time section” refers to a subdivision of digital information along a temporal axis, defined by a start time and an end time, and used as a unit of processing for long-duration information.

The term “content unit” refers to a subdivision of digital information along a semantic or structural axis, such as a chapter, a section, a slide, a topic, or a scene, used as a unit of processing.

The term “integration prompt sentence” refers to a prompt sentence that instructs a generative information processing model to integrate a plurality of pieces of summary information into overall summary information.

The term “overall summary information” refers to summary information that represents, in a unified form, an entirety of content of digital information based on integration of a plurality of partial summaries.

The term “degree of adaptation to emotion” refers to a parameter or set of parameters that specifies how strongly emotion information should influence the content, style, or emphasis of generated summary information.

In one embodiment, a server implements the claimed system by executing a computer program on one or more processors, a memory subsystem, and a communication interface connected to an information communication network. The server cooperates with at least one terminal operated by a user. The terminal comprises an input unit such as a camera and a microphone, a display device such as a flat-panel display or a head-mounted display, and a local processor capable of executing a communication program and a user interface program.

The server uses a storage subsystem, for example a disk array or a network-attached storage device, as an information storage apparatus to store digital information, intermediate processing results, summary information, multilingual summary information, and emotion-adjusted summary information. The server uses a network interface card and an operating system network stack as a communication apparatus to exchange data with the terminal over the information communication network.

The server analyzes acoustic information and visual information of digital information by using dedicated software components. For example, the server uses a media processing library such as a generic media conversion library to demultiplex and transcode audio-visual streams and to extract audio tracks from video files. The server uses a speech recognition engine, such as a cloud-based speech-to-text service or a locally deployed automatic speech recognition model, to convert acoustic information into character information. The server optionally uses an optical character recognition engine to convert textual regions in visual information into character information. The server constructs prompt sentences by executing a natural language processing program. In one embodiment, the server loads the character information into a text processing module that tokenizes the text, detects sentence boundaries, extracts named entities, computes term frequencies, and detects a primary language. The server also loads user attribute information, such as language preference and expertise level, and emotion information that is associated with the digital information. The server represents these items in a structured data record in memory. The server then generates a prompt sentence by applying a rule-based template engine that inserts specific parameters into a natural language template based on the detected features.

For example, the server generates a prompt sentence such as:
“Summarize the following Japanese financial results transcript in one concise Japanese sentence focusing on sales, operating profit, and net profit.”

In another example, when emotion information indicates that the user is confused and the user attribute information indicates that the user is not an expert, the server generates a prompt sentence such as:
“Summarize the following explanation in simple Japanese, avoiding technical terms, and add one short clarification for each key concept.”

The server inputs the prompt sentence and the associated character information into a generative AI model that is implemented as a neural-network-based generative information processing model. In one embodiment, the generative AI model is a transformer-based architecture comprising multiple encoder-decoder layers, self-attention heads, and feed-forward sublayers. The server represents the prompt sentence and the character information as token sequences. The server converts each token to a vector representation using an embedding matrix stored in model parameters. The server then performs a sequence of matrix multiplications, attention score calculations, non-linear activations, and layer normalizations to compute an output token probability distribution at each time step.

The server uses a decoding algorithm such as beam search or top-k sampling to generate summary information as a sequence of tokens. The server then reconstructs the textual summary information by mapping tokens back to character strings. Because the generative AI model processes both the prompt sentence and the character information in a unified attention space, the model can condition the summary information on the constraints specified by the prompt sentence. This internal mechanism allows the server to generate summaries of specified granularity, format, language, and emotion adaptation degree, which cannot be easily achieved by fixed rule-based summarization.

The server uses a loss function such as cross-entropy during a prior training phase of the generative AI model. The server, or an associated training system, adjusts model parameters by computing gradients of the loss function with respect to the parameters and updating the parameters using an optimization algorithm such as stochastic gradient descent or an adaptive moment estimation algorithm. The training data includes pairs of input texts and ideal summaries, optionally annotated with prompt sentences and emotion labels. During training, the server uses data augmentation techniques such as segmenting long texts, shuffling sentence order within boundaries, and generating synthetic prompt sentences to improve robustness. Because the generative AI model is pre-trained and optionally fine-tuned in this way, the run-time inference performed by the server yields summary information with improved accuracy and reduced error compared to rule-based summarization.

The server generates emotion-adjusted summary information by incorporating emotion information into the prompt sentence or by adding auxiliary feature tokens. For instance, when emotion information indicates that the user is excited, the server adds a phrase such as “The user is excited; emphasize positive achievements and future opportunities” to the prompt sentence. When emotion information indicates confusion, the server adds a phrase such as “The user is confused; explain the following text in simpler language and add clarifying examples.” The generative AI model internally assigns attention weights to these emotion-related tokens, and thereby modifies the distribution of generated tokens to produce a summary adapted to the emotional state. This mechanism uses a non-conventional, non-human heuristic that explicitly links low-level neural network attention weights to high-level emotional input, resulting in more technically sophisticated and context-sensitive summaries than those achievable by human operators in real time.

The server performs multilingual translation by using a translation processing apparatus. In one embodiment, the translation processing apparatus is a separate neural machine translation model with an encoder-decoder architecture trained on bilingual or multilingual corpora. In another embodiment, the translation processing apparatus is an external translation service accessed via an application programming interface. The server inputs the summary information into the translation processing apparatus as source language text and receives multilingual summary information in multiple target languages. The server stores language codes, source identifiers, and timestamps alongside the multilingual summary information in a structured table in the information storage apparatus. Because the server performs translation at the summary level and not at the entire input level, the server reduces the total amount of text processed by the translation processing apparatus, thereby reducing network bandwidth and translating time.

The server generates visual auxiliary information by constructing a visual-generation prompt sentence and sending it to an image generation processing apparatus. In one embodiment, the image generation processing apparatus is a generative neural network architecture such as a diffusion-based model or a generative adversarial network. The server encodes chart parameters, numerical values, and semantic descriptions derived from the digital information into the visual-generation prompt sentence. An example of such a prompt sentence is:
“Generate an infographic that shows year-on-year growth: sales +20%, operating profit +15%, net income +10%.”

The image generation processing apparatus receives the prompt sentence, converts it into an internal representation by a text encoder, and iteratively refines a latent image representation using a denoising process guided by learned parameters. The apparatus then decodes the latent representation into an image file, which the server stores in the information storage apparatus and transmits to the terminal. As a result, the terminal can display visual auxiliary information that is automatically aligned with the textual summary information, thus improving the usability of the output for users who need to interpret complex numerical data.

The terminal receives the summary information, multilingual summary information, emotion-adjusted summary information, and visual auxiliary information via the information communication network. The terminal caches the received data in local memory and renders the texts and images on the display device. The terminal selects a language and a presentation style according to local configuration and user preference, and overlays the summary information on playback of the underlying video or next to a displayed document. The terminal may perform additional processing, such as text-to-speech conversion of the summary information using a local speech synthesis engine, to output audio guidance to the user.

The terminal also captures user emotion information. The terminal acquires video frames of the user's face through the camera, and audio signals of user reactions through the microphone. The terminal transmits this sensor data, or derived feature vectors such as facial landmarks and prosodic features, to the server. In another embodiment, the terminal executes a local emotion recognition model based on a convolutional neural network for images and a recurrent or transformer network for audio. The terminal then transmits only emotion labels and confidence scores to the server, thereby reducing network traffic and enhancing privacy.

The server computes emotion information from the received data by using an emotion recognition model. In one embodiment, the emotion recognition model is a deep neural network trained to classify input facial images and prosodic patterns into a set of emotion categories. The server uses a loss function such as categorical cross-entropy during training and updates model weights using back-propagation. At run time, the server aggregates per-frame or per-segment emotion predictions over time, for example by computing a moving average or a weighted histogram, to derive a stable emotion profile for each time section of the digital information. The server then associates this emotion profile with corresponding portions of the character information and uses it when generating or updating prompt sentences.

Because the server structures data into explicit units, such as time sections and content units, the server can process long-duration digital information efficiently. The server divides the character information into segments, each associated with a time section or content unit. The server generates a separate prompt sentence for each segment, calls the generative AI model in parallel across segments using multiple concurrent threads or processes, and stores partial summary information for each segment. After obtaining all partial summaries, the server generates an integration prompt sentence that instructs the generative AI model to merge the partial summaries while avoiding redundancy and preserving global coherence. An example of such an integration prompt sentence is:
“Combine the following partial summaries into a single coherent overall summary of the entire presentation, avoid repeating points, and keep the result under 300 words in English.”

The generative AI model then outputs overall summary information. This hierarchical and parallel processing design reduces total processing time and memory footprint for long-duration streams compared to processing the entire digital information in a single model invocation. This technique constitutes a specific improvement to the operation of the computer system because it reduces the amount of data that each model invocation must handle and enables better load distribution across cores and machines.

The server improves communication efficiency by transmitting only summary information, multilingual summary information, and emotion-adjusted summary information, instead of transmitting full digital information or full transcripts to the terminals in many use cases. When visual auxiliary information is generated, the server may transmit compressed image files or encoded vector graphics. This approach reduces the number of bytes sent over the information communication network and can lower latency for users with constrained bandwidth. Furthermore, because the server caches and reuses summary information and multilingual summary information across multiple users, subsequent requests for the same content require minimal additional processing, further reducing computational overhead.

In another embodiment, the server uses different generative AI models for different tasks. For example, the server may use a first model that is optimized for financial documents and a second model that is optimized for conversational transcripts. The server selects an appropriate model based on content type determined from metadata or initial classification. This model selection improves accuracy and robustness. The server maintains a configuration table that maps content types to model identifiers and decoding parameters such as beam width and temperature, allowing fine-grained control over summarization behavior.

In a further embodiment, the server enforces non-conventional, explicit heuristics in the template engine for prompt sentence generation. For instance, the server may set an upper bound on the number of numerical values to be exposed in a summary for non-expert users, while allowing more numerical detail for expert users. The server may also define rules that require any mention of certain technical metrics to be accompanied by a plain-language paraphrase phrase, such as “a measure of profitability” or “a ratio related to shareholder return.” These heuristics operate before model inference and shape the inputs to the generative AI model in a way that systematically improves readability and comprehension. This differs from merely automating human summarization, because the server dynamically enforces constraints that would be difficult for a human operator to track across long and complex content in real time.

In still another embodiment, the server maintains detailed logs of prompt sentences, generated outputs, user feedback, and emotion profiles. The server analyzes these logs offline to adjust prompt templates and model parameters. For example, when user feedback indicates that summaries are too long for a specific content category, the server modifies the corresponding template to request fewer sentences. When emotion data indicates that confusion persists even after simplification, the server updates its rules to further reduce technical terms in that category. This feedback-driven adaptation improves the precision and efficiency of the summarization pipeline over time, thereby improving the technical performance of the system.

Because the server orchestrates media extraction, text conversion, structured prompt sentence construction, neural-network-based generative summarization, hierarchical aggregation, translation, emotion-adaptive re-generation, and visual auxiliary generation in a coordinated manner, the system improves the functioning of the computer itself. The server reduces redundant operations, manages data in well-defined segments and units, leverages parallelism in model inference, and tailors processing according to user and emotion context. As a result, the system achieves faster processing times, higher accuracy of summaries, reduced network load, and more effective utilization of storage resources compared to conventional systems that treat summarization, translation, and emotion analysis as separate, ad-hoc processes.

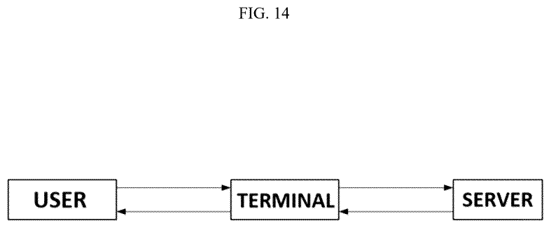

The following describes the processing flow using FIG. 14.

### Step 1:

Server acquires digital information.

Server receives, as input, digital information from a storage device or from a terminal via a network, where the digital information includes at least one of audio data, video data, and text data.

Server parses the input headers, identifies the media type, and stores the raw digital information in an information storage apparatus together with metadata such as content ID, source type, creation time, and user ID.

Server outputs a content record that references the stored digital information and its metadata.

### Step 2:

Server extracts audio and visual streams.

Server receives, as input, the content record and associated digital information.

Server invokes a media processing library to demultiplex the digital information, separates audio streams from video streams, and, if needed, converts the audio to a standardized format (for example, single-channel, fixed sampling rate).

Server outputs normalized audio data and, optionally, normalized video frames or streams, and updates the content record with paths to these normalized resources.

### Step 3:

Server converts acoustic information into character information.

Server receives, as input, the normalized audio data.

Server sends the audio data to a speech recognition engine and applies an acoustic model and language model to decode the waveform into a sequence of text tokens. Server then reconstructs sentences and aligns them with timestamps.

Server outputs character information (a transcript) and time alignment data, and stores both in the information storage apparatus.

### Step 4:

Server extracts character information from visual information.

Server receives, as input, normalized video frames or images associated with the content.

Server calls an optical character recognition engine on frames or regions likely to contain text, performs image preprocessing (such as binarization, scaling, and noise reduction), and decodes detected character regions into text strings.

Server outputs additional character information extracted from visual overlays or slides and merges this with the transcript, updating the content record with combined character information.

### Step 5:

Server consolidates and cleans character information.

Server receives, as input, character information from audio transcription and visual extraction.

Server executes a text processing module that merges overlapping segments, removes duplicate sentences, normalizes whitespace and punctuation, and detects the primary language. Server also computes structural markers such as paragraphs, sections, and speaker changes.

Server outputs cleaned, consolidated character information and structural annotations, and stores them in association with the content record.

### Step 6:

Server obtains user attribute information and emotion information.

Server receives, as input, a user identifier from the terminal and optional emotion data such as facial feature vectors, audio prosody features, or explicit emotion labels.

Server retrieves user attribute information from a user profile database, including language preference, expertise level, and preferred output format. Server analyzes the emotion data by using an emotion recognition model to infer an emotion label and confidence values.

Server outputs a user context object that contains user attribute information and emotion information, and associates this object with the content record.

### Step 7:

Server segments long-duration character information.

Server receives, as input, consolidated character information and structural annotations.

Server divides the character information into multiple segments based on time sections, paragraph boundaries, or topic changes. Server limits each segment to a pre-defined token size to respect the generative AI model's input constraints.

Server outputs a list of segment objects, each containing a portion of character information and associated metadata such as start time, end time, and segment index.

### Step 8:

Server generates a prompt sentence for each segment.

Server receives, as input, each segment object and the user context object.

Server applies a template engine that inserts segment-specific parameters, user language preference, summarization granularity, and emotion adaptation requirements into a natural-language template. For example, server generates: “Summarize the following Japanese financial results transcript in one concise Japanese sentence focusing on sales, operating profit, and net profit.” or “The user is confused; summarize the following text in simple terms and add one short clarification for each key concept.”

Server outputs, for each segment, a prompt sentence linked to the corresponding segment object.

### Step 9:

Server calls the generative AI model to create partial summaries.

Server receives, as input, a prompt sentence and the corresponding segment character information.

Server encodes the prompt sentence and segment text into token sequences, forwards them through a generative AI model (for example, a transformer-based model) and computes an output token distribution by performing attention operations and feed-forward computations. Server then decodes the tokens into natural-language text using a decoding strategy such as beam search.

Server outputs partial summary information for each segment and stores it with references to the source segments.

### Step 10:

Server integrates partial summaries into an overall summary.

Server receives, as input, a set of partial summary information items for all segments.

Server concatenates the partial summaries in order and constructs an integration prompt sentence such as: “Combine the following partial summaries into a single coherent overall summary of the entire presentation, avoid repeating points, and keep the result under 300 words in English.” Server then passes the integration prompt sentence and concatenated partial summaries to the generative AI model to generate an overall summary.

Server outputs overall summary information representing the entire digital information and associates it with the content record.

### Step 11:

Server generates emotion-adjusted summary information.

Server receives, as input, overall summary information, user context object, and, optionally, segment-level emotion profiles.

Server builds an emotion-aware prompt sentence that instructs the generative AI model how to adapt the summary to the user's emotion, such as: “The user felt strong joy during the parts about revenue growth. Rewrite the summary to emphasize those achievements, while keeping it under 150 words.” Server then inputs the emotion-aware prompt sentence and the overall summary information into the generative AI model, which regenerates a version tailored to the specified emotion.

Server outputs emotion-adjusted summary information and stores it alongside the original summary information.

### Step 12:

Server performs multilingual translation of summary information.

Server receives, as input, overall summary information and a list of target languages derived from user attribute information or system settings.

Server sends the summary text to a translation processing apparatus for each target language, which applies a translation model to map source text tokens to target language tokens. Server collects and validates translated outputs, ensuring correct language codes and character encoding.

Server outputs multilingual summary information and stores each language variant in association with the base summary.

### Step 13:

Server generates visual-generation prompt sentences.

Server receives, as input, summary information and numerical or categorical data extracted from the consolidated character information.

Server analyzes the summary to find quantitative metrics, trends, and entities, and then constructs visual-generation prompt sentences specifying desired charts or illustrations, such as: “Generate an infographic that shows year-on-year growth: sales +20%, operating profit +15%, net income +10%.”

Server outputs visual-generation prompt sentences prepared for use by an image generation processing apparatus.

### Step 14:

Server generates visual auxiliary information.

Server receives, as input, each visual-generation prompt sentence.

Server forwards the prompt sentence to an image generation processing apparatus that encodes the text, iteratively updates a latent image representation using learned parameters, and decodes the latent representation to an image. Server receives the generated image data, optionally compresses it, and stores it in the information storage apparatus.

Server outputs references (such as URLs or paths) to visual auxiliary information linked to the related summary information.

### Step 15:

Server packages and transmits results to the terminal.

Server receives, as input, a request from the terminal specifying a content ID and user ID.

Server retrieves, from the information storage apparatus, the corresponding overall summary information, multilingual summary information based on language preferences, emotion-adjusted summary information, and references to visual auxiliary information. Server constructs a response object that includes these items and serializes it into a structured format for network transmission.

Server outputs the serialized response and transmits it to the terminal via the information communication network.

### Step 16:

Terminal presents summaries and visuals to the user.

Terminal receives, as input, the response transmitted by the server.

Terminal parses the response, selects appropriate language versions, and loads referenced images. Terminal renders the text summaries as overlays, captions, or panels next to the digital information, and displays visual auxiliary information such as charts on the display device. Terminal may additionally invoke a local text-to-speech function to read the summaries aloud.

Terminal outputs a visual and/or auditory presentation that the user can perceive in real time.

### Step 17:

Terminal captures user emotion and feedback.

Terminal receives, as input, user interactions and sensor data.

Terminal captures facial images and voice signals, extracts features such as facial landmarks and pitch contours, and optionally classifies emotions locally. Terminal also records explicit feedback such as ratings or buttons pressed by the user. Terminal composes an emotion and feedback report and transmits it to the server.

Terminal outputs structured emotion information and feedback data that the server uses for subsequent processing.

### Step 18:

Server updates models and prompt generation rules based on feedback.

Server receives, as input, emotion and feedback data from the terminal together with identifiers of the summaries and prompt sentences that were displayed.

Server analyzes correlations between feedback and generated outputs, updates statistics such as average rating per template, and modifies prompt sentence templates or parameter settings (for example, desired length, level of simplification) for future sessions. In some embodiments, server also stores selected examples and feedback for use in periodic fine-tuning of the generative AI model or emotion recognition model.

Server outputs updated configuration data and, optionally, updated model parameters, thereby refining future processing flows.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

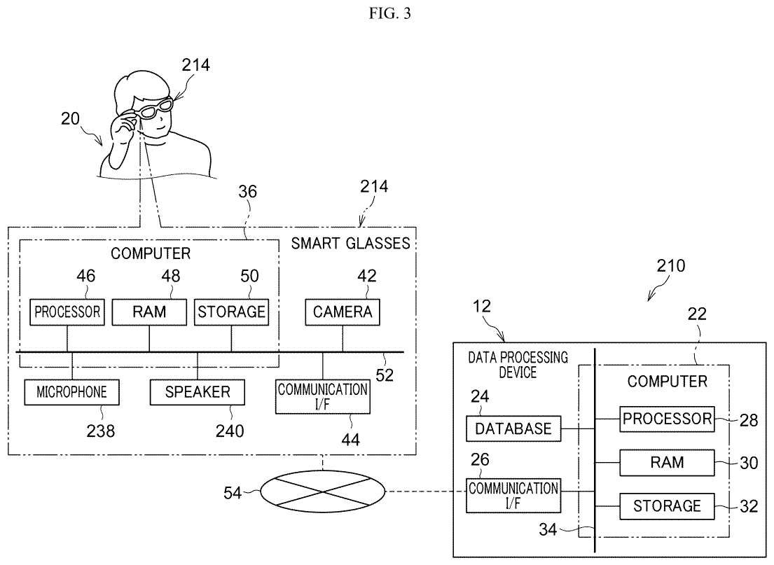

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

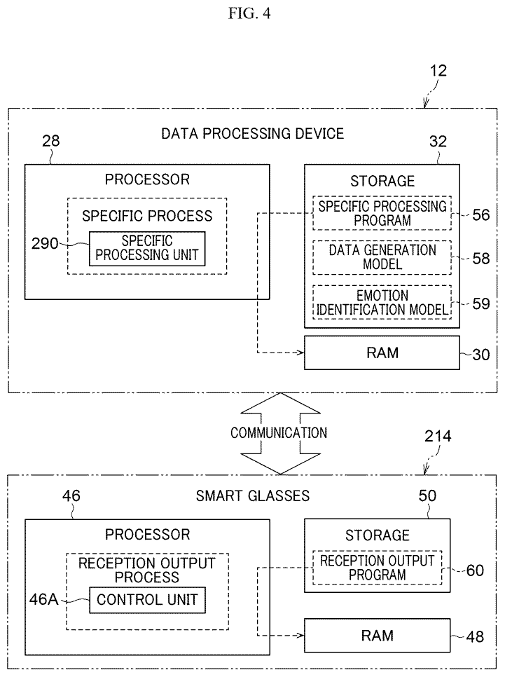

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

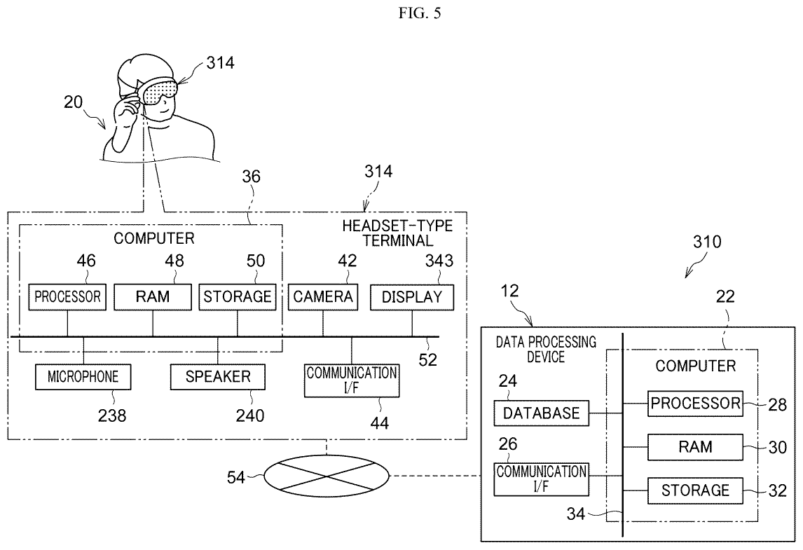

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

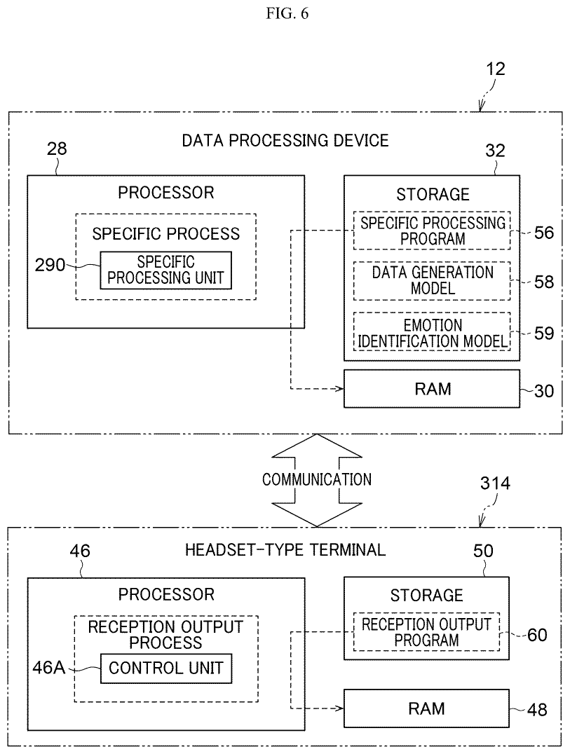

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

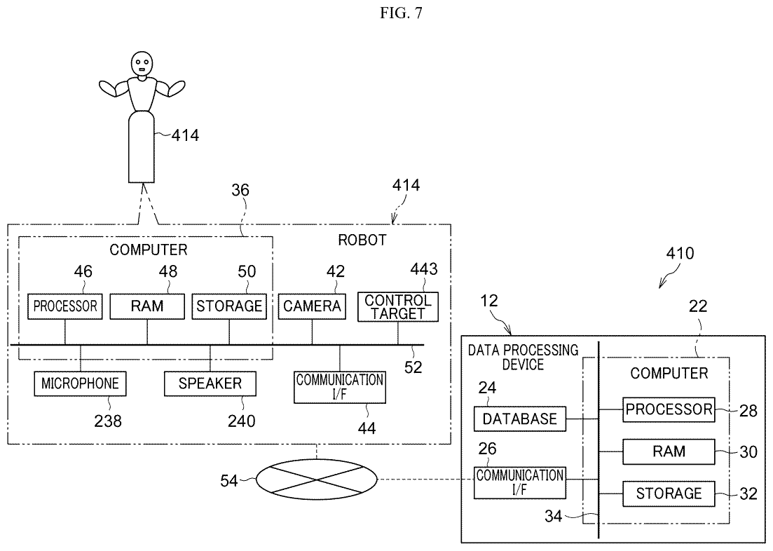

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

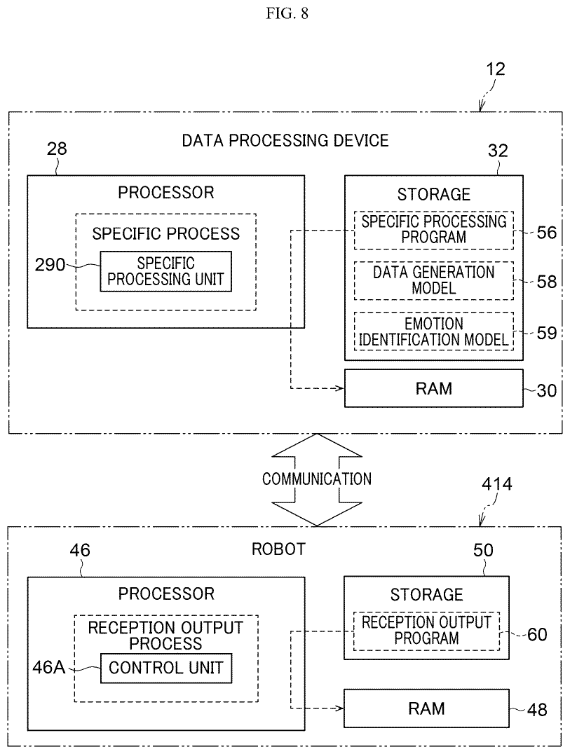

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https: //openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

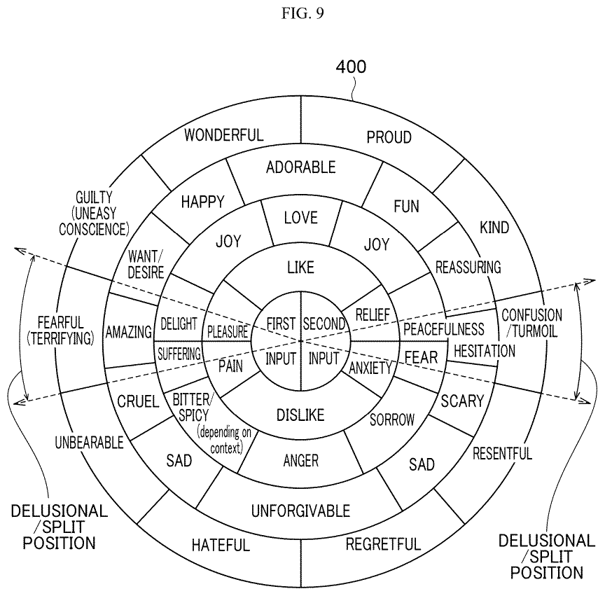

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

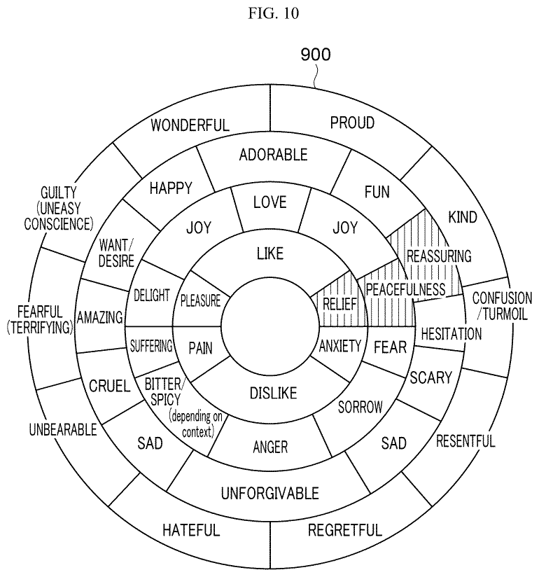

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive and preprocess electronic information of multiple types input from a user terminal via a communication network,
when the electronic information includes video information or audio information, extract an audio component from the video information, convert the audio component into a format suitable for speech recognition processing, and convert the audio component into character information by performing the speech recognition processing,
when the electronic information includes document information, extract the character information from the document information and normalize the character information,
execute natural language processing on the character information to extract important terms and topic information, and to generate structured information including at least a portion of a character string to be summarized,
generate a prompt sentence including the structured information and summarization conditions input from the user terminal,
input the prompt sentence and the structured information into a generative AI model, and generate summary information by performing inference processing based on deep learning,
automatically translate the summary information into a plurality of languages to generate multilingual summary information, and
transmit the multilingual summary information to the user terminal via the communication network for display or storage.

### Supplementary 2

The system according to supplementary 1,
wherein the processor is configured to
generate the prompt sentence by combining a user-specified prompt sentence input from the user terminal and an internal prompt sentence including the important terms, the topic information, and
extracted text generated by the natural language processing, and input the generated prompt sentence into the generative AI model.

### Supplementary 3

The system according to supplementary 1,
wherein the processor is configured to
when the electronic information includes long-duration video information or audio information, divide the electronic information into a plurality of partial information segments, generate the prompt sentence for each of the partial information segments, execute summarization processing by the generative AI model in parallel for the respective partial information segments, and integrate a plurality of partial summary information obtained from the partial information segments to generate the summary information.

### Application Example 1

### Supplementary 1

A system comprising a processor,
wherein the processor is configured to
receive viewing medium data as input data in an information processing apparatus and separate the viewing medium data into an audio component and a video component,
execute speech recognition processing on the audio component to generate character information, execute natural language processing on the character information to structure the character information on a sentence basis and format the structured character information as summarization target information,
construct a prompt sentence that instructs generation of summary information based on the summarization target information, input input data including the prompt sentence and the summarization target information into a generative artificial intelligence model, and generate the summary information by using the generative artificial intelligence model,
execute conversion processing on the summary information, in response to a user request, into different languages to generate multilingual summary information,
transmit the summary information and the multilingual summary information in a machine-readable format to a user information processing terminal via a communication network, generate association information indicating a correspondence between the summary information and the viewing medium data and transmit the association information to the user information processing terminal so that, in accordance with a user operation, a playback section of the viewing medium data corresponding to the summary information is selectable from the summary information, and
store the viewing medium data, the character information, the prompt sentence, and the summary information in association with identification information, and re-execute re-summarization processing or analysis processing by using a different prompt sentence based on stored contents.

### Supplementary 2

The system according to supplementary 1,
wherein the processor is configured to
process the viewing medium data including reporting medium data or explanatory medium data, divide the character information into a plurality of partial data portions in the natural language processing, construct the prompt sentence for each of the partial data portions, execute summarization processing by the generative artificial intelligence model in parallel for each of the partial data portions, and integrate results of the summarization processing executed in parallel to generate the summary information.

### Supplementary 3

The system according to supplementary 1,
wherein the processor is configured to
process the viewing medium data as sequential data that is transmitted continuously, execute the speech recognition processing and the summarization processing by the generative artificial intelligence model partially for each temporal division of the sequential data, and transmit partially generated summary information as update information to the user information processing terminal sequentially so that the user is able to grasp summary contents in real time while the viewing medium data is being played back.

### Example 2

### Supplementary 1

A system comprising a processor,
wherein the processor is configured to
receive digital information including audio information as input information and generate character information from the audio information,
generate a prompt sentence including summarization conditions and the character information, input the prompt sentence into a generative AI model, and cause the generative AI model to generate summary information on the basis of the character information,
cooperate with a user terminal to accept a correction operation by a user with respect to the summary information, acquire corrected summary information from the user terminal, and store the corrected summary information,
transmit the corrected summary information to an information processing resource having a translation processing function and acquire translation information in a plurality of languages, provide information including at least one of the summary information, the corrected summary information, and the translation information to the user terminal via a communication network, store, in association with the input information, at least the prompt sentence, the summary information, and the translation information, and manage the stored information so as to be reusable in subsequent processing for the input information, and
generate state information indicating a processing state of the input information and transmit the state information to the user terminal so that a progress status is displayable on the user terminal.

### Supplementary 2

The system according to supplementary 1,
wherein the processor is configured to acquire, as the digital information, video information including public information or explanatory information, extract the audio information from the video information, and use the extracted audio information as the input information for generating the character information to be supplied to the generative AI model.

### Supplementary 3

The system according to supplementary 1,
wherein the processor is configured to divide long-duration digital information into a plurality of segment information items, generate respective character information items corresponding to the plurality of segment information items, generate a plurality of prompt sentences respectively corresponding to the character information items, input the plurality of prompt sentences in parallel into the generative AI model to generate a plurality of summary information items respectively corresponding to the plurality of segment information items, and integrate the plurality of summary information items into overall summary information to be provided to the user terminal.

### Application Example 2

### Supplementary 1

A system comprising a processor,
wherein the processor is configured to acquire digital information and extract character information from acoustic information and/or visual information included in the digital information,
generate a prompt sentence that defines content of summarization processing, an output format, an output language, and a degree of adaptation to emotion, based on the character information and user attribute information and/or emotion information related to the digital information,
input the prompt sentence and the character information into a generative information processing model and cause the generative information processing model to generate summary information of the character information and emotion-adjusted summary information adjusted in accordance with the emotion information,
input the summary information into a translation processing apparatus and cause the translation processing apparatus to generate multilingual summary information in a plurality of languages, store the summary information, the multilingual summary information, and the emotion-adjusted summary information in association with each other in an information storage apparatus,
transmit at least one of the summary information, the multilingual summary information, and the emotion-adjusted summary information to a user information processing terminal via an information communication network, and
generate a visual-generation prompt sentence for generating visual auxiliary information corresponding to content of the digital information, input the visual-generation prompt sentence into an image generation processing apparatus to cause the image generation processing apparatus to generate the visual auxiliary information, and transmit a generation result of the visual auxiliary information to the user information processing terminal.

### Supplementary 2

The system according to supplementary 1,
wherein the processor is configured to
treat the digital information as information belonging to at least one of public announcement information, explanatory information, educational information, entertainment information, and news information, and to generate the prompt sentence so as to include content that specifies a summarization granularity, an expression format, and emphasis items in accordance with a type of the information and the user attribute information.

### Supplementary 3

The system according to supplementary 1,
wherein the processor is configured to
in a case where the digital information is long-duration information, divide the digital information into a plurality of time sections or content units, generate the prompt sentence for each of the units, input the prompt sentence for each of the units in parallel into the generative information processing model to obtain summary information for each of the units, and, after obtaining the summary information for each of the units, generate an integration prompt sentence using the summary information for each of the units as input, input the integration prompt sentence into the generative information processing model, and thereby generate overall summary information for the digital information.

What is claimed is:

1. A system comprising:
circuitry configured to:
receive, via a communication interface coupled to a packet-switched network, electronic information comprising at least one of video data, audio data, and document data from a terminal device;
extract an audio component from video data, convert the audio component into character data by executing speech recognition processing, and extract and normalize character data from document data;
execute natural language processing on the character data to extract term data and topic data and generate structured data comprising at least a portion of a character string to be summarized;
generate a prompt data structure by combining summarization condition data and a user-specified instruction received from the terminal device with an internal instruction comprising the structured data;
transmit the prompt data structure and the structured data to a generative neural network model to cause the generative neural network model to execute inference processing and generate summary data;
when the electronic information comprises long-duration data, divide the electronic information into a plurality of partial segments, generate the prompt data structure for each partial segment, execute summarization processing by the generative neural network model in parallel for the respective partial segments, and integrate partial summary data obtained from the respective partial segments to generate integrated summary data;
translate the summary data or the integrated summary data into a plurality of languages to generate multilingual summary data; and
transmit the multilingual summary data to the terminal device via the communication interface.

2. The system according to claim 1,
wherein dividing the electronic information comprises determining segment boundaries based on at least one of silence detection in the audio component, scene change detection in video data, and sentence boundary detection in the character data, and each partial segment comprises a contiguous portion of the electronic information bounded by the determined segment boundaries.

3. The system according to claim 2,
wherein the circuitry executes the summarization processing for the respective partial segments using a plurality of processing threads or a plurality of processing nodes, and integrating the partial summary data comprises concatenating the partial summary data in temporal order and executing a consolidation pass by the generative neural network model to produce coherent integrated summary data.

4. The system according to claim 1,
wherein the circuitry is further configured to separate viewing medium data into an audio component and a video component, execute speech recognition processing on the audio component, execute natural language processing to structure the character data on a sentence basis, and format the structured character data as summarization target data for input to the generative neural network model.

5. The system according to claim 4,
wherein the circuitry generates association data indicating a correspondence between the summary data and temporal positions in the viewing medium data, and transmits the association data to the terminal device so that a playback section of the viewing medium data corresponding to a portion of the summary data is selectable from the summary data.

6. The system according to claim 5,
wherein the circuitry stores the viewing medium data, the character data, the prompt data structure, and the summary data in association with identification data in a storage device, and re-executes summarization processing using a different prompt data structure based on the stored data without re-processing the original viewing medium data.

7. The system according to claim 1,
wherein the circuitry is further configured to receive audio data as input data, generate character data from the audio data by speech recognition processing, generate the prompt data structure comprising summarization conditions and the character data, and cause the generative neural network model to generate the summary data based on the character data.

8. The system according to claim 7,
wherein the circuitry cooperates with the terminal device to accept a correction operation by a user with respect to the summary data, acquires corrected summary data from the terminal device, stores the corrected summary data, and transmits the corrected summary data to a translation processing apparatus to acquire translation data in a plurality of languages.

9. The system according to claim 8,
wherein the circuitry stores, in association with the input data, at least the prompt data structure, the summary data, the corrected summary data, and the translation data, and manages the stored data so as to be reusable in subsequent processing for the input data.

10. The system according to claim 8,
wherein the circuitry generates state data indicating a processing state of the input data and transmits the state data to the terminal device so that a progress status is displayable on the terminal device.

11. The system according to claim 1,
wherein the circuitry is further configured to acquire user attribute data and emotion data associated with the electronic information, and generate the prompt data structure to include parameters defining a summarization content, an output format, an output language, and a degree of adaptation to emotion based on the emotion data.

12. The system according to claim 11,
wherein the circuitry causes the generative neural network model to generate emotion-adjusted summary data adjusted according to the emotion data, and stores the summary data, the multilingual summary data, and the emotion-adjusted summary data in association with each other in a storage device.

13. The system according to claim 12,
wherein the circuitry is further configured to generate a visual-generation prompt data structure for generating visual auxiliary data corresponding to content of the electronic information, transmit the visual-generation prompt data structure to an image generation apparatus to cause the image generation apparatus to generate the visual auxiliary data, and transmit the visual auxiliary data to the terminal device.

14. The system according to claim 1,
wherein the natural language processing comprises at least morphological analysis, named entity recognition, and keyword extraction, and the structured data comprises extracted entities, keywords, and topic labels associated with respective portions of the character data.

15. The system according to claim 1,
wherein the summarization condition data comprises at least one of a target summary length, a summarization style parameter, and a focus topic identifier received from the terminal device, and the prompt data structure includes the summarization condition data as constraint parameters for the generative neural network model.

16. The system according to claim 1,
wherein translating the summary data comprises transmitting the summary data to a machine translation apparatus and receiving translated data in each of the plurality of languages, and the circuitry stores the translated data indexed by language identifier for selective retrieval based on a language preference of the terminal device.

17. The system according to claim 1,
wherein the circuitry stores the prompt data structure, the structured data, and the summary data in a storage device indexed by content identification data, and provides the stored data for reuse in subsequent summarization requests without re-executing the speech recognition processing and the natural language processing.

18. A system comprising:
circuitry configured to:
receive electronic information comprising at least one of video data, audio data, and document data via a communication interface coupled to a packet-switched network;
convert audio components of the electronic information into character data by speech recognition, and execute natural language processing to generate structured data;
generate a prompt data structure comprising the structured data and summarization condition data, and transmit the prompt data structure to a generative neural network model to generate summary data;
when the electronic information comprises long-duration data, divide the electronic information into partial segments and execute parallel summarization processing to generate integrated summary data;
translate the summary data into a plurality of languages to generate multilingual summary data; and
transmit the multilingual summary data to a terminal device via the communication interface.

19. The system according to claim 18,
wherein the circuitry is further configured to acquire emotion data associated with the electronic information, include the emotion data in the prompt data structure, and cause the generative neural network model to generate emotion-adjusted summary data.

20. A method comprising:
receiving, by circuitry via a communication interface coupled to a packet-switched network, electronic information comprising at least one of video data, audio data, and document data;
extracting an audio component, converting the audio component into character data by speech recognition processing, and executing natural language processing to generate structured data;
generating a prompt data structure comprising the structured data and summarization condition data, and transmitting the prompt data structure to a generative neural network model to generate summary data;
when the electronic information comprises long-duration data, dividing the electronic information into partial segments, executing parallel summarization processing for the respective partial segments, and integrating partial summary data to generate integrated summary data;
translating the summary data into a plurality of languages to generate multilingual summary data; and
transmitting the multilingual summary data to a terminal device via the communication interface.
